(19) United States
(12) Patent Application Publication
(10) Pub. No.: US 2012/0170009 A1
(43) Pub. Date: Jul. 5, 2012

(54) FILTER BOX, FILTER APPARATUS, AND EXPOSURE APPARATUS

(75) Inventors: Koichi KATSURA, Kumagaya-shi (JP); Tsukasa OGIWARA, Kumagaya-shi (JP); Keiji MATSUURA, Saitama-shi (JP); Yoshinari HORITA, Konosu-shi (JP); Takashi MASUKAWA, Yokohama-shi (JP)

(73) Assignee: NIKON CORPORATION, Tokyo (JP)

(21) Appl. No.: 13/338,750

(22) Filed: Dec. 28, 2011

Related U.S. Application Data
(60) Provisional application No. 61/429,529, filed on Jan. 4, 2011.

(51) Int. Cl. G03B 27/52; B01D 46/00

(52) U.S. Cl. 355/30; 55/482; 355/77

(57) ABSTRACT

A plurality of filter boxes which hold chemical filters include: a first filter box having a frame which holds a chemical filter and which has a guide groove provided on a side surface of the frame; and a second filter box having a frame which holds a chemical filter and which has a guide groove provided on a side surface of the frame; wherein the guide groove of the first filter box and the guide groove of the second filter box are different from each other at least in one of a width and a depth thereof. A plurality of filters can be installed or exchanged efficiently or in such a manner that the filters are positioned easily.

### CROSS REFERENCE TO RELATED APPLICATION

The present application claims priority from U.S. Provisional patent application No. 61/429,529 filed on Jan. 4, 2011 all the disclosure of which is incorporated herein by reference in its entirety.

### FIELD OF THE INVENTION

The present invention relates, for example, to a filter box which holds a filter for removing, for example, any impurity, etc. contained in a gas, a filter apparatus provided with the filter box, an exposure apparatus provided with the filter apparatus, and a device producing method using the exposure apparatus.

### BACKGROUND OF THE INVENTION

In order to obtain a high exposure accuracy (resolution, positioning accuracy, etc.) in an exposure apparatus to be used in the lithography step of producing an electronic device (microdevice) including for example a semiconductor element, it is necessary that the illumination characteristic of an illumination optical system and the imaging characteristic of a projection optical system are maintained in predetermined states; and that the space, in which a reticle (or a photomask or the like), the projection optical system, and a wafer (or a glass plate or the like) are installed or placed, is maintained in a predetermined environment. For this purpose, the body section of the exposure apparatus (exposure apparatus-body section) including a part of the illumination optical system of the exposure apparatus, a reticle stage, the projection optical system, a wafer stage and the like has been hitherto installed in a box-shaped chamber. Further, an air-conditioning apparatus is provided, the air-conditioning apparatus supplying a clean gas (for example, air), which is controlled or regulated to have a predetermined temperature and which is allowed to pass through a dustproof filter or dust-preventive filter, into the chamber in accordance with the down flow system and the side flow system.

As for the exposure apparatus, in order to respond to the request for realizing an extremely fine circuit pattern in recent years, the wavelength of the exposure light (exposure light beam) is progressively shortened. Recently, the KrF excimer laser (wavelength: 248 nm) and the ArF excimer laser (wavelength: 193 nm) substantially in the vacuum ultraviolet region are used as the exposure light. In a case that the exposure light having such a short wavelength is used, if a minute amount of any gas of organic matter (organic gas) is present in a space (for example, the internal space in a barrel) through which the exposure light is allowed to pass, then the transmittance of the exposure light is lowered, and it is feared that any cloudiness substance may be produced on a surface of an optical element such as a lens element or the like on account of the reaction between the exposure light and the organic gas. Further, it is desirable that a gas of alkaline substance (alkaline gas) or the like, which reacts with the photoresist (photosensitive material) coated on the wafer, is also removed from the gas to be supplied into the chamber.

In view of the above, a plurality of chemical filters have been hitherto provided at a gas take-in portion of the air-conditioning apparatus of the exposure apparatus in order to remove, for example, the organic gas and/or the alkaline gas from the gas to be supplied into the chamber (see, for example, International Publication No. 2004/108252).

In a conventional exposure apparatus, a plurality of chemical filters have been stacked while being positioned in a casing. Therefore, when the chemical filters are exchanged, it is necessary that used chemical filters are successively unloaded, and then unused chemical filters are stacked and installed while being mutually positioned. Therefore, the time, which is required to exchange the chemical filters, is prolonged and/or it is feared that positional deviation or shift may be caused between the plurality of chemical filters, and the gas-tightness may be lowered between the chemical filters.

Further, in the exposure apparatus, the number of stages of the installed chemical filters is increased corresponding to the further improvement in the required exposure accuracy. Therefore, it is necessary that the chemical filters should be exchanged efficiently.

### SUMMARY OF THE INVENTION

Taking the foregoing circumstances into consideration, an object of the present invention is that a plurality of filters can be installed or exchanged efficiently or the filters can be positioned with ease.

According to a first aspect, there is provided a plurality of filter boxes which hold a plurality of filters including a first filter and a second filter. The filter boxes include a first filter box having a box-shaped first frame which holds the first filter and which has a first protrusion/recess-formed portion provided on at least one side surface of the first frame; and a second filter box having a box-shaped second frame which holds the second filter and which has a second protrusion/recess-formed portion provided on at least one side surface of the second frame; wherein the first protrusion/recess-formed portion has a first recess which is arranged between an upper end and a lower end of the first frame and which is communicated with a side end of the at least one side surface of the first frame, and a second recess which is communicated with the first recess and which extends toward the upper end of the first frame; the second protrusion/recess-formed portion has a third recess which is arranged between an upper end and a lower end of the second frame and which is communicated with a side end of the at least one side surface of the second frame, and a fourth recess which is communicated with the third recess and which extends toward the upper end of the second frame; and the first and second recesses and the third and fourth recesses are different from each other at least in one of a width and a depth thereof.

According to a second aspect, there is provided a filter apparatus which accommodates a filter therein, the filter apparatus including: the filter boxes of the present invention; and an accommodating section which accommodates the first frame and the second frame of the filter boxes; wherein the accommodating section includes a first engaging portion which engages with the first recess of the first frame to support the first frame and which engages with the second recess of the first frame to release the first frame from being supported, and a second engaging portion which engages with the third recess of the second frame to support the second frame and which engages with the fourth recess of the second frame to release the second frame from being supported.

According to a third aspect, there is provided an exposure apparatus which exposes a substrate with an exposure light via a pattern. The exposure apparatus includes: an exposure apparatus-body section which exposes the substrate and a chamber which accommodates the exposure apparatus-body section; the filter apparatus of the present invention; and an air-conditioning apparatus which feeds a gas taken in from outside of the chamber into the chamber via the filter apparatus.

According to a fourth aspect, there is provided a method for producing a device, including exposing a photosensitive substrate by using the above-described exposure apparatus; and processing the exposed photosensitive substrate.

### BRIEF DESCRIPTION OF THE DRAWINGS

FIG. 1 shows, with partial cutaway, a construction of an exposure apparatus of a first embodiment.

FIG. 2 shows a perspective view illustrating a filter apparatus 26 shown in FIG. 1.

FIG. 3A shows, with partial cutaway, a front view illustrating the filter apparatus 26 shown in FIG. 2; and

FIG. 3B shows an enlarged cross-sectional view of a shaft member 48A in FIG. 3A.

FIG. 4A shows a perspective view illustrating a filter box 38 shown in FIG. 3A, FIG. 4B shows a side view illustrating the filter box 38, FIG. 4C shows a perspective view illustrating a filter box 40 shown in FIG. 3A, and FIG. 4D shows a side view illustrating the filter box 40.

FIGS. 5A, 5B, 5C, and 5D show perspective views illustrating change of the relative position between the filter box 38 and a casing 28 respectively.

FIGS. 6A, 6B, 6C, and 6D show perspective views illustrating change of the relative position between the filter box 40 and the casing 28 respectively.

FIG. 7 shows, with partial cutaway, a front view of a filter apparatus 26A of a second embodiment.

FIG. 8 shows a flow chart illustrating exemplary steps of producing an electronic device.

### DESCRIPTION OF THE PREFERRED SPECIFIED EMBODIMENTS OF THE INVENTION

### First Embodiment

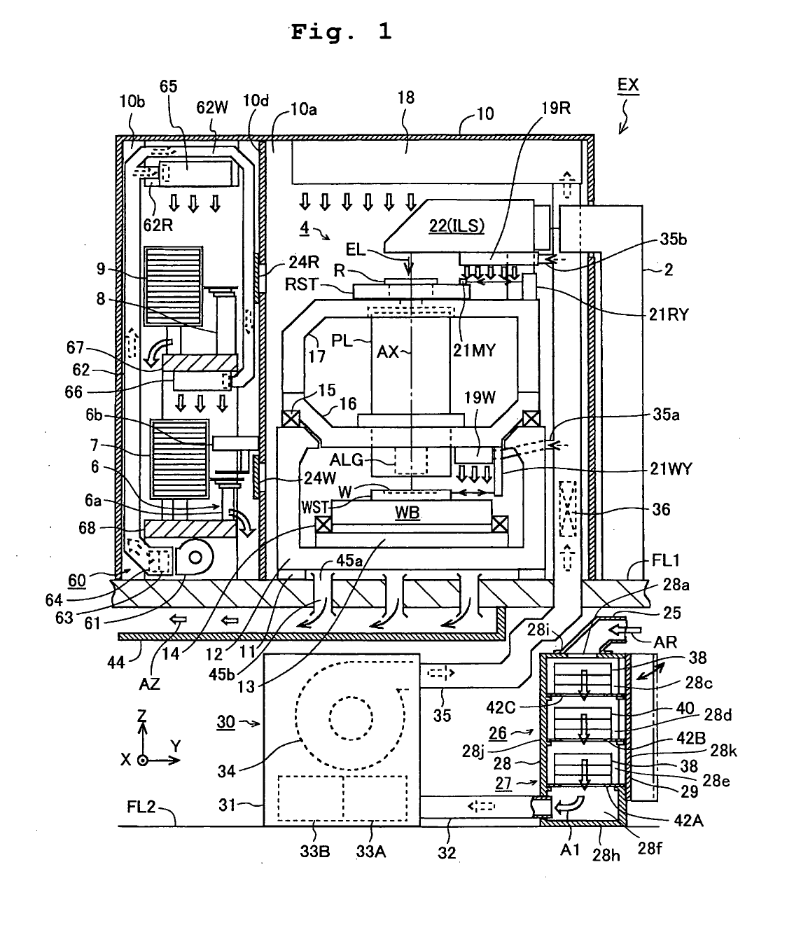

A first embodiment will be explained below with reference to FIGS. 1 to 6.

FIG. 1 shows, with partial cutaway, an exposure apparatus EX according to this embodiment which is of the scanning exposure type and is constructed of a scanning stepper. With reference to FIG. 1, the exposure apparatus EX includes a light source section 2 which generates an exposure light (illumination light or illumination light beam for the exposure) EL, an illumination optical system ILS which illuminates a reticle R (mask) with the exposure light EL, a reticle stage RST which is movable while holding the reticle R, and a projection optical system PL which projects an image of a pattern of the reticle R onto a surface of a wafer W (substrate) coated with a photoresist (photosensitive material). The exposure apparatus EX further includes a wafer stage WST which is movable while holding the wafer W, other driving mechanisms, sensors, etc., a reticle library 9 which stores a plurality of reticles, a wafer cassette 7 which stores a plurality of unexposed wafers and/or a plurality of exposed wafers, and a main controller (not shown) which integrally controls the operation of the exposure apparatus EX. The members, which include those ranging from the light source section 2 to the main controller (not shown), are installed or placed, for example, on an upper surface of a first floor FL1 in a clean room of a semiconductor device production factory.

The exposure apparatus EX is provided with a box-shaped chamber 10 having a high gas-tightness and installed on the floor FL1. The interior of the chamber 10 is comparted or partitioned into an exposure chamber 10a and a loader chamber 10b, for example, by a partition member 10d which has two openings that are opened/closed by shutters 24R, 24W. An exposure apparatus-body section 4, which includes the illumination optical system ILS, the reticle stage RST, the projection optical system PL, and the wafer stage WST, is installed in the exposure chamber 10a. A reticle loader system and a wafer loader system, which include the reticle library 9 and the wafer cassette 7 respectively, are installed in the loader chamber 10b.

The exposure apparatus EX is provided with an overall air-conditioning system for performing the air-conditioning for the whole interior of the chamber 10. The overall air-conditioning system includes a filter apparatus 26 which is installed on an upper surface of a second floor FL2 of a machine room as the lower floor of the first floor FL1 and which has a plurality of stacked chemical filters, an air-conditioning apparatus 30 which has an air-conditioning apparatus-body section 31 installed on the upper surface of the floor FL2, a large-sized blow port 18 which is installed at an upper portion of the exposure chamber 10a, a small-sized blow port 19R which is arranged on a bottom surface of a subchamber 22 accommodating the illumination optical system ILS, and a small-sized blow port 19W which is arranged in the vicinity of the projection optical system PL. The filter apparatus 26 removes predetermined impurities from the air AR as the air-conditioning gas supplied via a piping 25 so that the air, from which the impurities have been removed, is supplied to the air-conditioning apparatus-body section 31 via a first duct 32 as indicated by an arrow A1 (details will be described later on).

The air-conditioning apparatus 30 includes the first duct 32, the air-conditioning apparatus-body section 31, a second duct 35 which connects the air-conditioning apparatus-body section 31 and the interior of the chamber 10 via an opening provided on the floor FL1, and a dustproof filter or dust-preventive filter 36 such as ULPA filter (Ultra Low Penetration Air-filter) or the like which is arranged, for example, at an intermediate position of the second duct 35 and which removes minute particles (fine particles) from the air flowing in the inside of the second duct 35. Each of the ducts 32, 35 and the piping 25 is formed by using a material with which the amount of production of the contaminant or pollutant is small, including, for example, stainless steel and fluororesin.

The air-conditioning apparatus-body section 31 is provided with a temperature control section 33A which controls the temperature of the air supplied via the first duct 32, a humidity control section 33B which controls the humidity of the air, and a fan motor 34 which feeds the air toward the second duct 35. The air is controlled to have a temperature of, for example, 23° C. within a range of 20° C. to 30° C., and the air is supplied in accordance with the down flow manner or system into the exposure chamber 10a via the second duct 35 and the blow port 18. The interior of the chamber 10 is set to be in a state of positive pressure in accordance with the supply of the air. The air in the second duct 35 is supplied into the exposure chamber 10a via branched tubes 35a, 35b and the blow port 19W and the blow port 19R corresponding thereto, respectively. A part of the air in the exposure chamber 10a is also allowed to flow into the loader chamber 10b.

As an example, the air, flowing through the interior of the chamber 10 (exposure chamber 10a), flows into an underfloor discharge duct 44 via a number of openings 45a provided on the bottom surface of the chamber 10 and a number of openings 45b provided on the floor FL1. The air indicated by an arrow AZ in the discharge duct 44 is discharged after being cleaned via an unillustrated filter. All or a part of the air flowing to the discharge duct 44 can be also reused by returning all or the part of the air toward the piping 25.

With reference to FIG. 1, the following description will be made assuming that Z axis extends in parallel to an optical axis AX of the projection optical system PL, X axis extends perpendicularly to the sheet surface of FIG. 1 in a plane perpendicular to the Z axis (substantially parallel to a horizontal plane in this embodiment), and Y axis extends in parallel to the sheet surface of FIG. 1 in the plane perpendicular to the Z axis. In this embodiment, the scanning direction for the reticle R and the wafer W during the scanning exposure is the Y direction. The directions of rotation about the X axis, the Y axis, and the Z axis are also referred to as θx, θy, and θz directions.

At first, the light source section 2, which is installed on the floor FL1 and disposed outside the chamber 10, includes an exposure light source which generates or emits the ArF excimer laser beam (wavelength: 193 nm) as the exposure light (exposure light beam) EL, and a beam-feeding optical system which guides the exposure light EL to the illumination optical system ILS. The light-exit end of the exposure light EL of the light source section 2 is arranged in the exposure chamber 10a via an opening disposed at an upper portion of the side surface in the +Y direction of the chamber 10. Those usable as the exposure light source also include an ultraviolet pulsed laser light source such as a KrF excimer laser light source (wavelength: 248 nm) or the like, a high harmonic wave generating light source of YAG laser, a high harmonic wave generator of solid-state laser (semiconductor laser or the like), a mercury lamp (for example, i-ray), etc.

The illumination optical system ILS, which is arranged at the upper portion in the chamber 10, includes, for example, an illuminance-uniformalizing optical system including an optical integrator, a reticle blind, a condenser optical system, etc. as disclosed, for example, in United States Patent Application Publication No. 2003/0025890. A slit-shaped illumination area of a pattern surface of the reticle R, which is elongated or slender in the X direction and which is defined by the reticle blind, is illuminated with the exposure light EL at a substantially uniform illuminance by the illumination optical system ILS.

The image of the pattern in the illumination area, which is included in a pattern area formed on the reticle R, is projected and imaged on a surface of the wafer W via the projection optical system PL which is telecentric on the both sides and which has a projection magnification β of reduction magnification (for example, ¼).

A lower frame 12 is installed on the floor FL1 in the exposure chamber 10a of the chamber 10 via a plurality of bases 11. A flat plate-shaped base member 13 is fixed to a central portion of the lower frame 12. A flat plate-shaped wafer base WB is supported on the base member 13 via anti-vibration bases 14 which are disposed, for example, at three positions. The wafer stage WST is placed on the upper surface of the wafer base WB parallel to the XY plane via an air bearing so that the wafer stage WST is movable in the X direction and the Y direction and rotatable in the θz direction. An optical system frame 16 is supported at the upper end of the lower frame 12 via anti-vibration bases 15 which are disposed, for example, at three positions and which are arranged to surround the wafer base WB. The projection optical system PL is arranged in an opening disposed at a central portion of the optical system frame 16. An upper frame 17 is fixed on the optical system frame 16 so that the projection optical system PL is surrounded thereby.

A Y axis laser interferometer 21WY is fixed at the end portion in the +Y direction of the bottom surface of the optical system frame 16. An X axis laser interferometer (not shown) is fixed at the end portion in the +X direction of the bottom surface of the optical system frame 16. A wafer interferometer, which is constructed of these interferometers, radiates a plurality of axes of measuring beams onto reflecting surfaces (or movement mirrors) disposed on side surfaces of the wafer stage WST respectively to measure the positions of the wafer stage WST in the X direction and the Y direction and the angles of rotation in the θx, θy, and θz directions, for example, with the references of reference mirrors (not shown) disposed on side surfaces of the projection optical system PL; and the wafer interferometer supplies measured values to the main controller (not shown).

A stage control system in the main controller (not shown) controls the positions and the velocities in the X direction and the Y direction and the angle of rotation in the θz direction of the wafer stage WST via a driving mechanism (not shown) including a linear motor or the like based on the measured value obtained by the above-described wafer interferometer, a measured value obtained by an autofocus sensor (not shown), and/or the like. Further, the stage control system controls a Z stage (not shown) in the wafer stage WST so that the surface of the wafer W is focused on the image plane of the projection optical system PL. Further, an alignment system ALG, etc. is also provided in order to perform the alignment for the reticle R and the wafer W.

On the other hand, the subchamber 22, which accommodates the illumination optical system ILS, is fixed to the upper portion in the +Y direction of the upper frame 17. Further, the reticle stage RST is placed on the upper surface, of the upper frame 17, parallel to the XY plane via an air bearing so that the reticle stage RST is movable at a constant velocity in the Y direction, movable in the X direction, and rotatable in the θz direction.

A Y axis laser interferometer 21RY is fixed to the end portion in the +Y direction of the upper surface of the upper frame 17. An X axis laser interferometer (not shown) is fixed to the end portion in the +X direction of the upper surface of the upper frame 17. A reticle interferometer, which is constructed of these interferometers, radiates a plurality of axes of measuring beams, for example, onto a movement mirror 21MY, etc. provided on the reticle stage RST respectively to measure the positions of the reticle stage RST in the X direction and the Y direction and the angles of rotation in the θz, θx, and θy directions, for example, with the references of reference mirrors (not shown) disposed on side surfaces of the projection optical system PL; and the reticle interferometer supplies measured values to the main controller (not shown).

The stage control system contained in the main controller (not shown) controls the position and the velocity in the Y direction, the position in the X direction, the angle of rotation in the θz direction, etc. of the reticle stage RST, via a driving mechanism (not shown) including a linear motor or the like based on, for example, the measured value obtained by the reticle interferometer.

In a case that the exposure apparatus EX of this embodiment is of the liquid immersion type, a predetermined liquid (pure or purified water, etc.) is supplied to a local liquid immersion area, disposed between the wafer W and an optical member arranged at the forward end of the projection optical system PL, from a local liquid immersion mechanism (not shown) including, for example, a ring-shaped nozzle head arranged at the lower surface of the optical member disposed at the lower end of the projection optical system PL. A liquid immersion mechanism, which is disclosed, for example, in United States Patent Application Publication No. 2007/242247, can be used as the local liquid immersion mechanism. In a case that the exposure apparatus EX is of the dry type, it is unnecessary to provide the liquid immersion mechanism.

The reticle library 9 and a reticle loader 8 as a horizontal articulated robot are installed on an upper surface of an upper support stand 67 in the loader chamber 10b. The reticle loader 8 exchanges the reticle R between the reticle library 9 and the reticle stage RST via the opening which is opened/closed by the shutter 24R of the partition member 10d.

A wafer cassette 7 and a horizontal articulated robot 6a for taking in and taking out the wafer with respect to the wafer cassette 7 are installed on an upper surface of a lower support stand 68 in the loader chamber 10b. A wafer transport apparatus 6b, which constructs the wafer loader 6 together with the horizontal articulated robot 6a, is installed over or above the horizontal articulated robot 6a. The wafer transport apparatus 6b transports the wafer W between the horizontal articulated robot 6a and the wafer stage WST via the opening which is opened/closed by the shutter 24W of the partition member 10d.

When the exposure is performed by using the exposure apparatus EX, the alignment is firstly performed for the reticle R and the wafer W. After that, the radiation or irradiation of the exposure light EL onto the reticle R is started. An image of the pattern (pattern image) of the reticle R is transferred to one shot area on the surface of the wafer W in accordance with a scanning exposure operation in which the reticle stage RST and the wafer stage WST are synchronously moved (subjected to the synchronous scanning) in the Y direction at a velocity ratio of the projection magnification R of the projection optical system PL, while projecting an image of a part of the pattern of the reticle R onto the shot area on the surface of the wafer W via the projection optical system PL. After that, the pattern image of the reticle R is transferred to all shot areas of the wafer W in the step-and-scan manner by repeating an operation in which the wafer W is step-moved in the X direction and the Y direction via the wafer stage WST and the scanning exposure operation described above.

In the next viewpoint, the exposure apparatus EX of this embodiment is provided with the overall air-conditioning system including the air-conditioning apparatus 30 which supplies the temperature-regulated clean air into the chamber 10 in accordance with the down flow system as described above in order to perform the exposure at a high exposure accuracy (resolution, positioning accuracy, etc.) while maintaining the illumination characteristic (the illuminance uniformity, etc.) of the illumination optical system ILS and the imaging characteristic (resolution, etc.) of the projection optical system to be in predetermined states and maintaining the atmosphere (space) for placing or installing the reticle R, the projection optical system PL, and the wafer W therein to be in a predetermined environment.

The overall air-conditioning system is provided with a local air-conditioning section. That is, the temperature-regulated clean air is supplied from the branched tubes 35b, 35a of the second duct 35 to the blowing portion 19R disposed on the bottom surface of the subchamber 22 and the blowing portion 19W disposed on the bottom surface of the optical system frame 16 respectively. In this case, the blowing portions 19R, 19W are arranged on the optical paths of the measuring beams of the Y axis laser interferometer 21RY for the reticle stage RST and the Y axis laser interferometer 21WY for the wafer stage WST respectively. The blowing portions 19R, 19W respectively cause the temperature-regulated air to be blown onto the optical paths of the measuring beams at an approximately uniform air velocity distribution in accordance with the down flow system (or the side flow system as well). Similarly, the temperature-regulated air is also locally supplied to the optical paths of the measuring beams of the X axis laser interferometers. Accordingly, the positions of the reticle stage RST and the wafer stage WST can be measured highly accurately by the reticle interferometer 21R and the wafer interferometer 21W, etc.

A local air-conditioning apparatus 60 is installed in the loader chamber 10b. The local air-conditioning apparatus 60 is provided with a small-sized fan motor 61 which is arranged on the bottom surface of the support stand 68, a duct 62 which supplies the air fed by the fan motor 61 to the upper portion, and blow ports 65, 66 which are arranged over or above the reticle library 9 and the wafer cassette 7, respectively. The forward end portion of the duct 62 is divided into branched tubes 62R, 62W which supply the air to the blow ports 65, 66 respectively. Dustproof filters such as ULPA filters or the like are installed in the vicinity of air inflow ports of the blow ports 65, 66 respectively. Filter boxes 63, 64, which accommodate chemical filters for removing predetermined impurities, are installed in the duct 62 in the vicinity of the fan motor 61. As an example, the chemical filter of the filter box 63 removes the organic gas (gas of organic matter), and the chemical filter of the filter box 64 removes the alkaline gas (gas of alkaline substance) and the acid gas (gas of acid substance).

When the local air-conditioning apparatus 60 is operated in the loader chamber 10b, the air, which is fed from the fan motor 61, is supplied to the space in which the reticle library 9 and the wafer cassette 7 are arranged respectively in accordance with the down flow system from the blow ports 65, 66 via the filter boxes 63, 64 and the duct 62. The air flowing around the reticle library 9 is returned to the fan motor 61 via the surroundings of the support stand 67, the surroundings of the wafer cassette 7 disposed under or below the support stand 67, and the surroundings of support stand 68. The air supplied from the blow port 66 to the surroundings of the wafer cassette 7 is returned to the fan motor 61 via the surroundings of the support stand 68. The air returned to the fan motor 61 is supplied again into the loader chamber 10b from the blow port 65, 66 via the filter boxes 63, 64 and the dustproof filters. In this way, the air in the loader chamber 10d is retained in a clean state by the local air-conditioning apparatus 60.

Next, an explanation will be made about the construction of the filter apparatus 26 connected to the air-conditioning apparatus 30 in the overall air-conditioning system of this embodiment. The filter apparatus 26 is provided with an accommodating box 27 which is box-shaped and which has an openable/closable window or window section; and a plurality of first filter boxes 38 and a plurality of second filter boxes 40 which are accommodated in the accommodating box 27. As an example, the accommodating box 27 has a slender box-shaped casing 28 which is slender or elongated in the Z direction; and partition plates 42A, 42B, 42C which divide the space in the casing 28 into four spaces. With the partition plates 42A, 42B and 42C, the space in the casing 28 is divided into a first space 28c sandwiched or interposed by an upper plate 28i of the casing 28 and the partition plate 42C, a second space 28d interposed by the partition plate 42B and the partition plate 42C, a third space 28e interposed by the partition plate 42A and the partition plate 42B, and a fourth space 28f interposed by the partition plate 42A and a bottom plate 28h of the casing 28. Three stages of the first filter boxes 38 are installed and stacked on the upper surface of the partition plate 42A; three stages of the second filter boxes 40 are installed and stacked on the upper surface of the partition plate 42B; and three stages of the first filter boxes 38 are installed and stacked on the upper surface of the partition plate 42C.

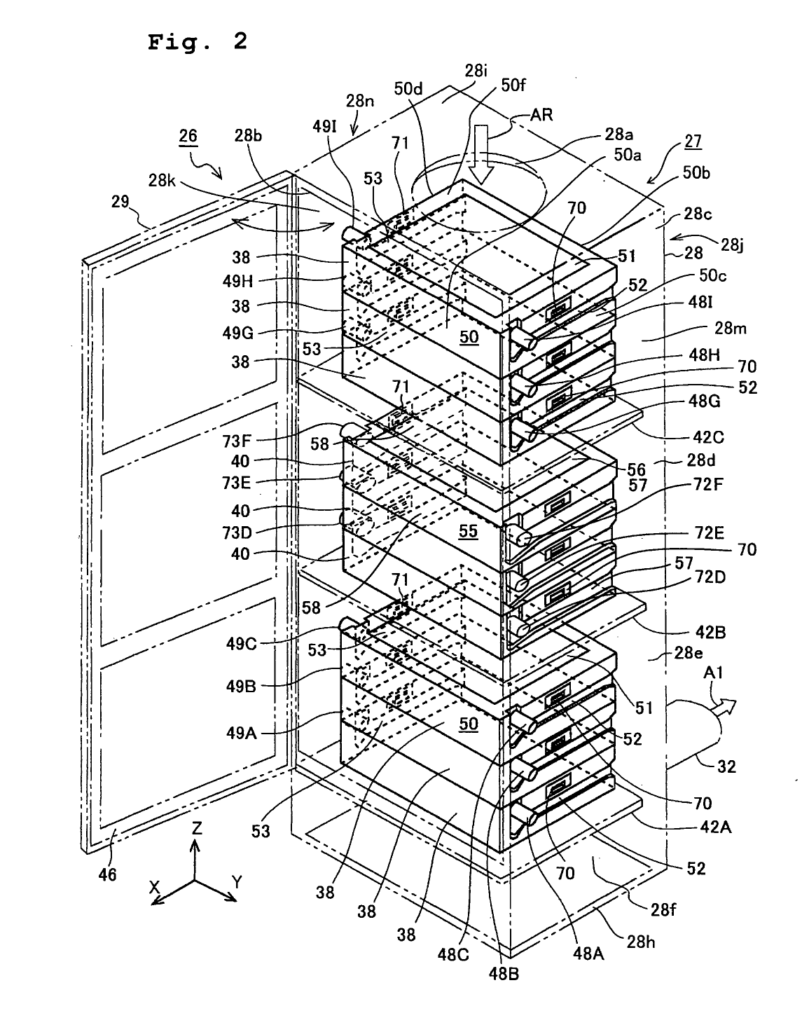

Further, the accommodating box 27 has a door 29 which is installed openably/closably to the casing 28 via hinge mechanisms (not shown) disposed at a plurality of positions in order that the window is opened to take in/out the filter boxes 38, 40 during the exchange of the filter boxes 38, 40. Here, a side of the window of the casing 28 which is closed by the door 29 is referred to as a “front surface 28k” of the casing 28, and a side (far side or rear side) facing or opposite to the window of the casing 28 is referred to as a “back surface 28j” of the casing 28, and two surfaces laterally connecting the front surface 28k and the back surface 28j are referred to as “side surfaces 28m, 28n” (see FIG. 2) of the casing 28. An opening 28a is formed through the upper plate 28i of the casing 28. An end portion of the piping 25 for introducing the air-conditioning air AR is fixed to the upper plate 28i. The first duct 32 is connected to the fourth space 28f which is the lowermost space of the casing 28.

Note that actually the door 29 is arranged in the casing 28 at a portion thereof on the side of +X direction, and the first duct 32 is connected to the casing 28 at a portion thereof on the side in the −X direction.

FIG. 2 shows the filter apparatus 26 shown in FIG. 1 in a state that the door 29 of the casing 28 is open. In FIG. 2, the casing 28 and the door 29 are depicted by two-dot chain lines for the convenience of explanation. In the inside of the casing 28 of the accommodating box 27 shown in FIG. 2, a chemical filter 51, which removes the organic gas (gas of organic matter), is retained or held in a box-shaped (rectangular frame-shaped) frame 50 having open upper and lower portions respectively in relation to each of the three stages of filter boxes 38 stacked on the upper surface of the lowermost stage partition plate 42A and the three stages of filter boxes 38 stacked on the upper surface of the uppermost stage partition plate 42C. A chemical filter 56, which removes the acid gas (gas of acid substance) and the alkaline gas (gas of alkaline substance) including ammonia, amine, etc. is retained or held in a box-shaped (rectangular frame-shaped) frame 55 having open upper and lower portions respectively in relation to each of the three stages of filter boxes 40 stacked on the upper surface of the middle stage partition plate 42B.

Each of the filter boxes 38, 40 has a height of, for example, 200 mm to 400 mm, and each of the filter boxes 38, 40 has a weight of about 10 kg to 20 kg.

Those usable as the chemical filter 51 for removing the organic gas include, for example, activated carbon type filters and ceramics type filters. Those usable as the chemical filter 56 for removing the alkaline gas and the acid gas include impregnated activated carbon type filters, ion exchange resin type filters, ion exchange fiber type filters, impregnated ceramics type filters, and the like. Each of the frames 50, 55, the partition plates 42A to 42C, the casing 28, and the door 29 is formed of, for example, a material which has the corrosion resistance and which scarcely undergoes the degassing or the like, for example, stainless steel or aluminum (aluminum subjected to the almite treatment or processing) formed with an oxide coating (aluminum oxide or the like) on the surface. Each of the frames 50, 55, etc. can be also formed of, for example, a material including a resin material which has the corrosion resistance and which scarcely undergoes the degassing (laminated plate coated with polyethylene or fluorine-based resin, etc.).

By removing the organic gas, the transmittance of the exposure light EL is improved in the exposure chamber 10a of the chamber 10, and the appearance of the cloudiness substance is suppressed, which would be otherwise formed on the surface of the optical element on account of the interaction between the organic gas and the exposure light EL. Further, by removing the alkaline gas and the acid gas, the change in the characteristic of the photoresist of the wafer W, etc. is suppressed. In particular, in a case that the photoresist is the chemical amplification type photoresist, if any alkaline gas such as ammonia, amine or the like is present in the air, then it is feared that the produced acid might react to form a hardly soluble layer on the surface of the photoresist. Therefore, it is especially effective to remove the alkaline gas such as ammonia, amine or the like.

The chemical filters, which are accommodated in the filter boxes 63, 64 in the loader chamber 10b shown in FIG. 1, are constructed in the same manner as the chemical filters 51, 56. However, the filter boxes 63, 64 are small-sized as compared with the filter boxes 38, 40.

With reference to FIG. 2, protrusions/recesses are formed to be symmetrical by guide grooves (first protrusion/recess-formed portions) 52, 53 on the both side surfaces in the longitudinal direction (Y direction) of each of the frames 50 of the six filter boxes 38 in total disposed on the partition plates 42A, 42C.

In this embodiment, the guide grooves 52, 53 are directly formed on the side surfaces of the frame 50. Therefore, the side surfaces of the frame 50 function as guide surfaces for loading or transporting the filter box 38 into the casing 28 at a predetermined position in the casing 28. Grip portions 70, 71, each of which is formed of a recess to be gripped by an operator manually or by hand, are attached to portions disposed over or above the guide grooves 52, 53 on the both side surfaces of the frame 50. A forward end portion of each of columnar-shaped or stick-like shaped shaft members (guides) 48A, 48B, 48C, 48G, 48H, 48I which are fixed to the inner surface of the casing 28 respectively is engaged with the guide groove 52 disposed on one side surface of one of the filter boxes 38; and a forward end portion of each of columnar shaft members 49A, 49B, 49C, 49G, 49H, 49I, which are fixed to the inner surface of the casing 28 so as to face or be opposite to the shaft members 48A, 48B, 48C, 48G, 48H, 48I, respectively, is engaged with the guide groove 53 disposed on the other side surface of one of the filter boxes 38. The shaft members 48A, 48B, 48C, 48G, 48H, 48I and the shaft members 49A, 49B, 49C, 49G, 49H, 49I have a shape same with one another, and each are fixed detachably to the inner surface of the casing 28 with a screw. The frames 50 of the filter boxes 38 are positioned in the X direction (short side direction) and the Y direction by the shaft members 48A, 49A, 49C, 49G, 49H, 49I, respectively.

Further, in FIG. 2, protrusions/recesses are formed by guide grooves (second protrusion/recess-formed portions) 57, 58 on the both side surfaces in the longitudinal direction (Y direction) of each of the frames 55 of the three filter boxes 40 disposed on the partition plate 42B. In this embodiment, the guide grooves 57, 58 are directly formed on the side surfaces of the frame 55. Therefore, the side surfaces of the frame 55 function as guide surfaces for loading or transporting the filter box 40 into the second space 28d at a predetermined position in the casing 28. Grip portions 70, 71 are attached to portions disposed over or above the guide grooves 57, 58 on the both side surfaces of the frame 55. The forward end portion of each of columnar shaft members 72D, 72E, 72F fixed to the inner surface of the casing 28 respectively is engaged with the guide groove 57 disposed on one side surface of one of the filter boxes 40. Further, the forward end portion of each of columnar shaft members 73D, 73E, 73F fixed to the inner surface of the casing 28 so as to face or be opposite to the shaft members 72D, 72E, 72F, respectively is engaged with the guide groove 58 disposed on the other side surface of one of the filter boxes 40. The frames 55 of the three filter boxes 40 are fixed by the self-weights, in a state of being positioned in the X direction and the Y direction by the shaft members 72D, 73D, etc.

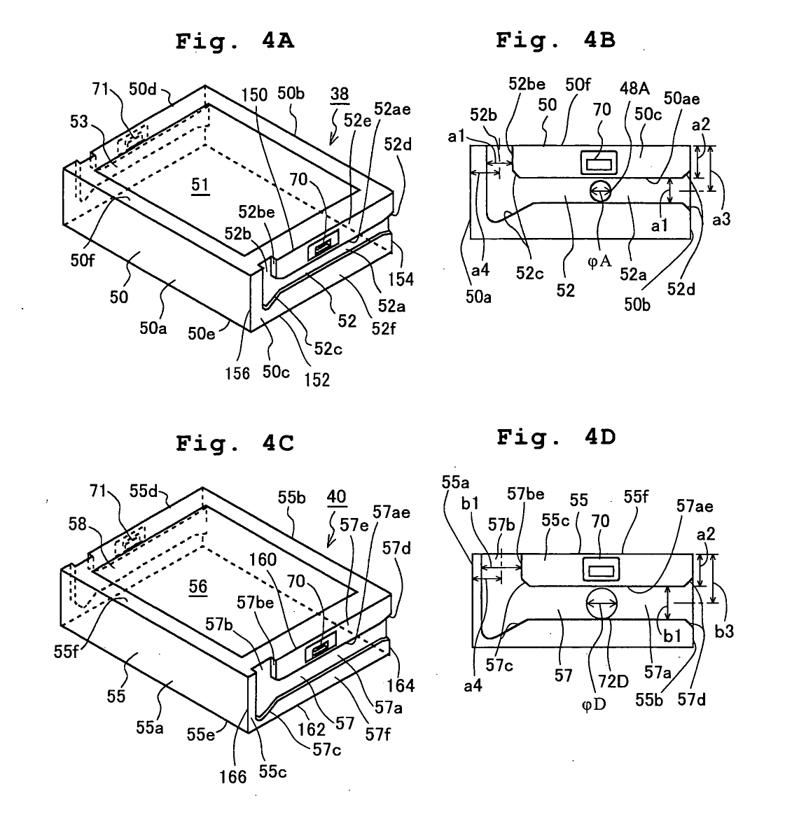

The shape of the shaft members 72D to 72F is same as the shape of the shaft members 73D to 73F; and the shape of the shaft member 72D is similar to that of the shaft member 48A. Note that, however, a diameter φD of the forward end portion of the shaft member 72D is formed to be greater than a diameter φA of the forward end portion of the shaft member 48A (see FIGS. 4B, 4D). As described above, the accommodating box 27 is provided with the shaft members 48A to 48C, 48G to 48I, the shaft members 49A to 48C, 49G to 49I, and the shaft members 72D to 72F, 73D to 73F.

Note that the frame 50 of the lower stage filter box 38 is fixed by the self-weight in a state of being positioned with respect to the upper surface of the partition plate 42A. Further, the frame 55 of the middle stage filter box 40 is fixed by the self-weight in a state of being positioned with respect to the upper end surface of the lower stage filter box 38 and the upper surface of the partition plate 42B. Furthermore, the frame 50 of the upper stage filter box 38 is fixed by the self-weight in a state of being positioned with respect to the upper end surface of the middle stage filter box 40 and the upper surface of the partition plate 42C.

In this case, the frame 50 of the filter box 38 and the frame 55 of the filter box 40 have the same outer shape (same outer dimension), and are different from each other in the shapes of the guide grooves 52, 53 and the guide grooves 57, 58 formed on the both side surfaces in the Y direction. In this embodiment, the width of the guide grooves 57, 58 of the frame 55 is formed to be wider (greater) than the width of the guide grooves 52, 53 of the frame 50. Therefore, the diameter φD of the forward end portion of each of the shaft members 72D, 73D which are engaged with the guide grooves 57, 58 of the frame 55 is formed to be greater than the diameter φA of the forward end portion of each of the shaft members 48A, 49A which are engaged with the guide grooves 52, 53 of the frame 50 (see FIGS. 4B, 4D). Accordingly, by the operator's sight or sense, the filter box 40, which has the chemical filter 56 for removing the alkaline gas and the acid gas, is prevented from being installed on the partition plates 42A, 42C and reversely, the filter box 38, which has the chemical filter 51 for removing the organic gas, is prevented from being installed on the partition plate 42B. Further, the shaft members 48A to 48C, 48G to 48I, 49A to 49C and 49G to 49I which fix the filter boxes 38 have the distances from the front surface 28k of the casing 28 which are set to be same as the distances from the front surface 28k of the casing 28 to the shaft members 72D to 72F and 73D to 73F which fix the filter boxes 40. In other words, the shaft members 48A to 48C, 48G to 48I and shaft members 72D to 72F are arranged along a straight line substantially parallel to the Z axis; and the shaft members 49A to 49C and 49G to 49I and shaft members 73D to 73F are arranged along a straight line substantially parallel to the Z axis. Therefore, the centers of the respective six stages of filter boxes 38 and the centers of the respective three stages of filter boxes 40 are arranged along a same straight line parallel to the Z axis, in a state of being positioned in the casing 28.

Further, a rectangular window 28b is formed on the front surface 28k of the casing 28 in order to take in/out the filter boxes 38, 40. A gasket 46 is fixed to the door 29 in order to hermetically close a space between the door 29 and the end portions of the partition plates 42B, 42C and the surroundings of the window 28b when the window 28b of the casing 28 is closed by the door 29. The gasket 46 can be formed of a material which is excellent in the corrosion resistance and which scarcely undergoes the degassing, including, for example, a sheet of Teflon (trade name of DuPont), a sheet of silicone rubber, etc.

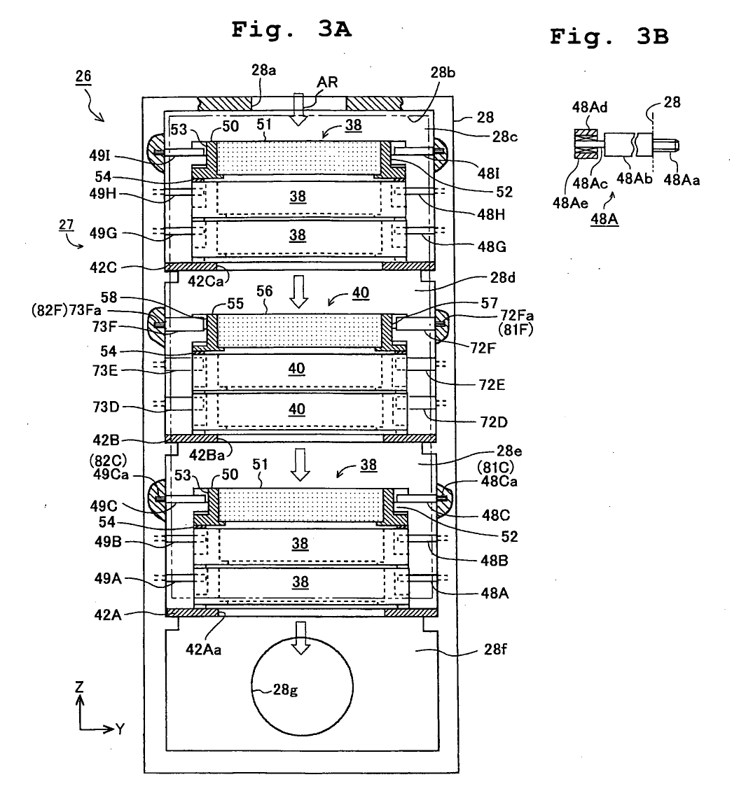

Furthermore, in the next viewpoint, FIG. 3A shows the casing 28 of the accommodating box 27 shown in FIG. 2 with partial cutaway as viewed from the front surface (forward surface) thereof. With reference to FIG. 3A, openings 42Aa, 42Ba, 42Ca, through which the air AR having passed through the filter boxes 38, 40 is allowed to pass, are formed on the partition plates 42A to 42C respectively. A rectangular frame-shaped gasket 54 (sealing member disengageable from the installing surface), which is provided to enhance the gas-tightness with respect to the placing surface, is fixed to each of the bottom surfaces of the frames 50 of the filter boxes 38 and the frames 55 of the filter boxes 40. The material of the gasket 54 can be formed of a material which is excellent in the corrosion resistance and which scarcely undergoes the degassing, including, for example, a sheet of Teflon (trade name of DuPont), a sheet of silicone rubber, etc. Note that the material of the gasket 54 may be the same as or equivalent to the material of the gasket 46. As a result, the gas, in the space 28c interposed between the partition plate 42C and the upper plate of the casing 28 formed with the opening 28a, necessarily or always passes through the chemical filters 51 of the three stages of the filter boxes 38, and then the gas passes through the opening 42Ca to flow into the space 28d interposed between the partition plates 42B, 42C. Similarly, the gas in the space 28d passes through the chemical filters 56 of the three stages of the filter boxes 40, and then the gas passes through the opening 42Ba to flow into the space 28e interposed between the partition plates 42A, 42B. Similarly, the gas in the space 28e necessarily passes through the chemical filters 51 of the three stages of the filter boxes 38, and then the gas passes through the opening 42Aa, the space 28f defined with the bottom surface of the partition plate 42A, and an opening 28g disposed on the back surface of the casing 28, and flows to the first duct 32 shown in FIG. 2. Therefore, the air AR, which is allowed to inflow from the opening 28a disposed at the upper portion of the casing 28, necessarily passes through the three stages of the filter boxes 38 for removing the organic gas, the three stages of the filter boxes 40 for removing the alkaline gas and the acid gas, and the three stages of the filter boxes 38 for removing the organic gas, and the air AR is supplied to the air-conditioning apparatus 30 shown in FIG. 1. Therefore, the air, from which the impurities have been removed to a high extent, is supplied into the chamber 10.

As shown in FIG. 3A, the shaft members 48A to 48C, 48G to 48I, 49A to 49C, 49G to 49I and the shaft members 72D to 72F, 73D to 73F are fixed to screw holes 81C, 82C and screw holes 81F, 82F of which sizes are same to one another and which are formed in the side surfaces (inner sides) of the casing 28, respectively, by screw portions 48Ca, 49Ca and screw portions 72Fa, 73Fa as representatively illustrated by the shaft members 48C, 49C and the shaft members 72F, 73F. Accordingly, it is possible to fix shaft members which have a same shape as that of the shaft members 72D, 73D and of which forward end portion is more thicker (greater) than that of the shaft members 48A to 48C, 48G to 48I, 49A to 49C, 49G to 49I, instead of providing the shaft members 48A to 48C, 48G to 48I, 49A to 49C, 49G to 49I, so as to arrange the filter boxes 40 instead of arranging the filter boxes 38. On the contrary, it is possible to fix shaft members which have a same shape as that of the shaft members 48A, 49A and of which forward end portion is more slender (thinner) than that of the shaft members 72D to 72F, 73D to 73F, instead of providing the shaft members 72D to 72F, 73D to 73F, so as to arrange the filter boxes 38 instead of arranging the filter boxes 40.

As shown in FIG. 3B that is an enlarged cross-sectional view, the shaft member 48A is constructed, as an example, of a screw portion 48Aa which is screwed into a screw hole formed in the inner surface of the casing 28; a first rod portion 48Ab which is continued (connected) to the screw portion 48Aa; a second rod portion 48Ac which has a slender shape and which is connected to the first rod portion 48Ab; and a rotary body 48Ae which is connected to the second rod portion 48Ac via a rotary bearing 48Ad. The screw portion 48Aa, the first rod portion 48Ab and the second rod portion 48Ac are formed of a same member. The rotary body 48Ae of the shaft member 48A is arranged in the guide groove 52 of the filter box 38, and the rotary body 48Ae is rotated when the filter box 38 is moved. Further, with respect to the shaft member 49A arranged on the opposite side of the shaft member 48A, a rotary body (not shown) provided on the forward end portion of the shaft member 49A is also arranged in the guide groove 53 on the opposite side of the guide groove 52. Therefore, the filter box 38 can be moved smoothly.

With respect to the shaft members 72D, 73D, a rotary body (not shown) of which diameter is greater than that of the rotary body 48Ae is fixed to the forward end portion of each of the shaft members 72D, 73D via a rotary bearing, in a similar manner as with the shaft member 48A. Further, since the rotary bodies of the shaft members 72D, 73D are arranged in the guide grooves 57, 58, respectively, of the filter box 40, the filter box 40 can be moved smoothly.

Further, with reference to FIG. 3A, the spaces, which enable the operator to insert the hands, are secured between the both inner side surfaces of the casing 28 and the side surfaces in the Y direction of the filter boxes 38, 40. Accordingly, when the filter boxes 38, 40 are loaded and unloaded, the operator can move the filter boxes 38, 40 by gripping the grip portions 70, 71 disposed on the side surfaces of the filter boxes 38, 40, by the hands, in the casing 28 shown in FIG. 2.

Next, an explanation will be made about the shapes of the guide grooves 52, 53 of the frame 50 of the filter box 38 and the guide grooves 57, 58 of the frame 55 of the filter box 40.

Here, regarding the frame 50 of the filter box 38, when the filter box 38 (frame 50) is inserted in the casing 28, a surface of the frame 50 which faces or is opposite to the front surface 28k (in a case that the back or dorsal surface of the casing 28 faces the side edges of the side surfaces on one side of the frame, then the front surface faces the side edges of the side surfaces on the other side, of the frame, opposite to the side edges on the one side) of the casing 28 is referred to as a front surface 50a (first surface) of the frame 50; a surface facing the back surface 28j of the casing 28 is referred to as a back surface 50b (second surface) of the frame 50; and surfaces facing the side surfaces 28m, 28n of the casing 28 are referred to as side surfaces 50c, 50d (third and fourth surfaces) of the frame 50. In the embodiment, although the side surfaces 50c, 50d of the frame 50 are perpendicular to the front surface 50a and the back surface 50b, there is no limitation to the perpendicularity. For example, at least one of the front surface 50a and the back surface 50b of the frame 50 may intersect or cross (incline with respect to 90 degrees) with respect to the side surfaces 50c, 50d of the frame 50. A surface of the frame 50 located above (on the upper side) with respect to the front surface 50a and the back surface 50b is referred to as an upper surface 50f; and a surface of the frame 50 located below (on the lower side) with respect to the front surface 50a and the back surface 50b is referred to as a bottom surface 50e (see FIG. 4A). The respective surfaces of frame 55 of the filter box 40, which will be described later on, are also specified in a similar manner as regarding the frame 50 of the filter box 38.

As shown in FIG. 4A, the guide grooves (first protrusion/recess-formed portions) 52, 53 are formed on the pair of side surfaces 50c, 50d in the longitudinal direction of the frame 50 of the first filter box 38. The guide groove 52 has a first groove (first recess) 52a which is arranged between an upper end 150 and a lower end 152 of the side surface 50c of the frame 50 and which is communicated with a back-side end 154 or the back surface 50b of the frame 50; and a second groove (second recess) 52b which is communicated with the first groove 52a and which extends toward the upper end 150 of the frame 50 (in a direction toward the upper surface 50f). The side surface 50c is divided by the guide groove 52 into an upper side portion 52e and a lower side portion 52f. The first groove (lateral recess) 52a is formed between the bottom surface 50e and the upper surface 50f of the frame 50 so that the first groove 52a extends in the lateral direction (X direction) along the bottom surface 50e and the upper surface 50f, and the second groove (vertical recess) 52b is formed between a front-side end 156 and the back-side end 154 of the frame 50, namely between the front surface 50a and the back surface 50b of the frame 50 so that the second groove 52b extends in the vertical direction (Z direction) along the front and back surfaces 50a and 50b.

Further, the guide groove 52 has a first tapered portion 52c which is formed at a position of communication between the first groove 52a and the second groove 52b and which has a width gradually narrowed from the side of the front surface 50a of the frame 50 toward the side of the back side end 154 or toward the side of the back surface 50b of the frame 50, and a second tapered portion 52d which is formed at a portion, of communication with the back surface 50b, of the first groove 52a and which has a width gradually widened toward (narrowed in a direction away from) the side of the back surface 50b, from the side of the front surface 50a of the frame 50. An edge portion 50ae (lower end portion of the upper side portion 52e, of the side surface 50c, divided by the guide groove 52) disposed on the side of the upper surface 50f of the first groove 52a and an edge portion 50be (side end portion of the upper side portion 52e, of the side surface 50c, divided by the guide groove 52) disposed on the side of the back surface 50b of the second groove 52b are connected by the first tapered portion 52c.

As shown in a side view of FIG. 4B, a width a1 of the first groove 52a and the second groove 52b of the frame 50 are set to be somewhat or slightly wider than the diameter φA of the forward end portion of the shaft member 48A provided in the casing 28 shown in FIG. 2. Accordingly, the shaft member 48A can be relatively moved (can be slidably moved) with respect to the frame 50 smoothly between the back surface 50b and the upper surface 50f of the frame 50 along the guide groove 52.

Note that since the shape of the guide groove 53 on the other side surface 50d of the frame 50 is symmetrical to the guide groove 52 with respect to the center line (not shown in the drawings) in the front and back direction of the frame 50 (hereinbelow referred to simply as “symmetrical”) or has a same shape as that of the guide groove 52, the explanation for the guide groove 53 will be omitted.

On the other hand, as shown in FIG. 4C, the guide grooves (second protrusion/recess-formed portions) 57, 58 are formed on a pair of side surfaces 55c, 55d in the longitudinal direction of the frame 55 of the second filter box 40. The side surface 55c is divided by the guide groove 57 into a first portion (small portion) 57e and a second portion (large portion) 57f. The guide groove 57 has a first groove 57a (third recess) which is arranged between an upper end 160 and a lower end 162 of the side surface 55c of the frame 55 and which is communicated with a back side end 164 or a back surface 55b of the frame 55; and a second groove 57b (fourth recess) which is communicated with the first groove 57a and which extends toward the upper end 160 of the frame 55 (in a direction toward an upper surface 55f). The first groove 57a is formed between the bottom surface 55e and the upper surface 55f of the frame 55, and the second groove 57b is formed between the back side end 164 and a front side end 166 of the side surface 55, namely between a front surface 55a and the back surface 55b of the frame 55 at a position closer to the front surface 55a.

Further, the guide groove 57 also has a first tapered portion 57c which is formed at a position of communication between the first groove 57a and the second groove 57b and which has a width gradually narrowed toward the back surface 55b of the frame 55, and a second tapered portion 57d which is formed at a portion, of communication with the back surface 55b, of the first groove 57a and which has a width gradually widened toward the back surface 55b. An edge portion 57ae (the lower end portion of the first portion 57e) disposed on the side of the upper surface 55f of the first groove 57a and an edge portion 57be (the side end portion of the first portion 57e) disposed on the side of the back surface 55b of the second groove 57b are connected by the first tapered portion 57c.

As shown in a side view of FIG. 4D, a width b1 of the first groove 57a and the second groove 57b is set to be somewhat or slightly wider than the diameter φD of the shaft member 72D provided in the casing 28 shown in FIG. 2 (φD<b1). Accordingly, the shaft member 72D can be relatively moved (slidably movable) with respect to the frame 55 smoothly between the back surface 55b and the upper surface 55f of the frame 55 along the guide groove 57. In this embodiment, the width b1 of the grooves 57a, 57b of the guide groove 57 is greater than the width a1 of the grooves 52a, 52b of the guide groove 52 in FIG. 4B (a1<b1); the diameter φD of the forward end portion of the shaft member 72D is greater than the diameter φA of the forward end portion of the shaft member 48A (φA<φD); and the diameter φD of the forward end portion of the shaft member 72D is greater than the width a1 of the grooves 52a, 52b of the guide groove 52 (a1<φD). With this, the forward end portion of the shaft member 72D cannot pass through the guide groove 52 (grooves 52a, 52b) of the frame 50 in FIG. 4B. Note that difference between the width b1 of the grooves 57a, 57b of the guide groove 57 and the width a1 of the grooves 52a, 52b of the guide groove 52 can be set to be not less than 5 mm, preferably to be not less than 10 mm.

Further, a distance a4 from the center of the second groove 57b with respect to the front surface 55a of the frame 55 of the filter box 40 is set to be same as a distance a4 from the center of the second groove 52b with respect to the front surface 50a of the frame 50 of the filter box 38. Furthermore, a distance a2 of the first groove 57a with respect to the upper surface 55f of the frame 55 is set to be same as a distance a2 of the first groove 52a with respect to the upper surface 50f of the frame 50; and the grip portions 70 are arranged in the frames 55 and 50 at substantially same positions, respectively. In this case, a distance b3 from a center of the first groove 57a with respect to the upper surface 55f of the frame 55 is longer than a distance a3 from a center of the first groove 52a with respect to the upper surface 50f of the frame 50.

Note that since the shape of the guide groove 58 on the other side surface 55d of the frame 55 is symmetrical to the guide groove 57, the explanation for the guide groove 58 will be omitted.

The frames 50, 55 can be produced by, for example, the mold molding or mold forming. Note that it is also possible to make the distance b3 from the center of the first groove 57a with respect to the upper surface 55f of the frame 55 be approximately same as the distance a3 from the center of the first groove 52a with respect to the upper surface 50f of the frame 50. In such a case, the distance between the first groove 57a and the upper surface 55f of the frame 55 becomes short. Thus, it is allowable to make the size (dimension) of the grip portions 70, 71 on the side of the frame 55 be smaller than that of the grip portions 70, 71 on the side of the frame 50.

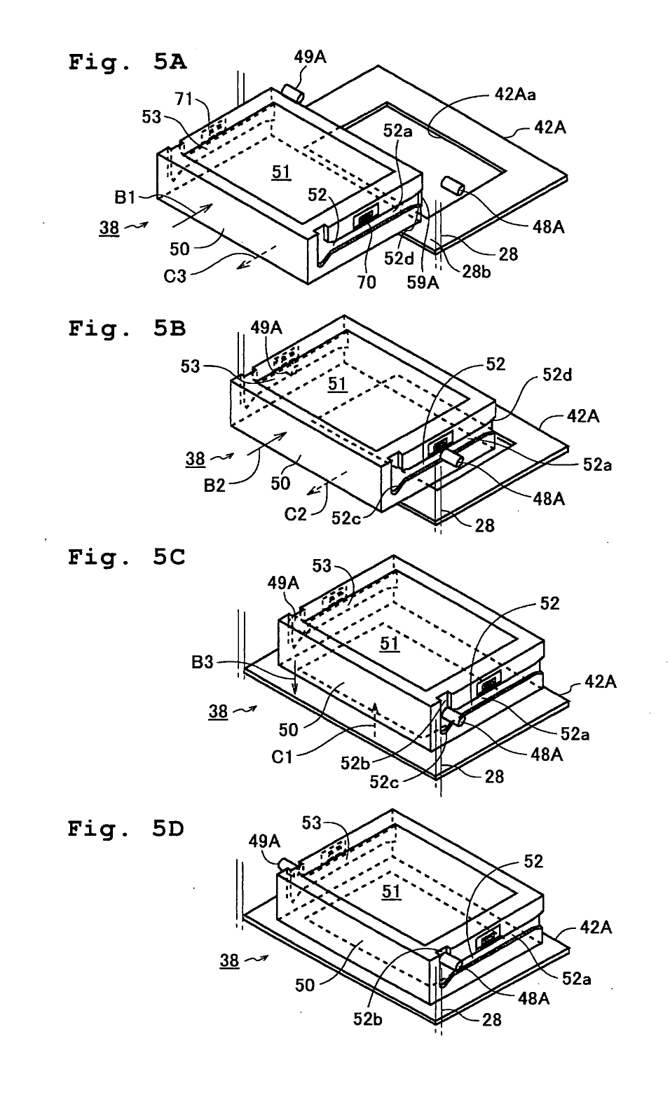

Next, an explanation will be given about a case that the filter box 38 shown in FIG. 4A is installed or arranged on the upper surface of the partition plate 42A of the casing 28 shown in FIG. 2. In this case, as shown in FIG. 5A, the operator moves the first groove 52a and the equivalent of the guide grooves 52, 53 of the filter box 38 (frame 50) to the positions located in front of the pair of shaft members 48A, 49A of the casing 28 in a state that the filter box 38 is held via the grip portions 70, 71 of the frame 50.

In an unused filter box 38, a thin film 59A is provided in a stretched form at the inlet of the first groove 52a of the frame 50 so that the thin film 59A can be exfoliated. The filter box 38 is pushed and inserted into the casing 28 via the window 28b as shown by an arrow B1, and the filter box 38 is further pushed and inserted so that the shaft member 48A is relatively moved slidably with respect to the frame 50 along the first groove 52a as shown by an arrow B2 in FIG. 5B. By doing so, the film 59A is exfoliated. Therefore, when the filter box 38 is unloaded in the next time, it is possible to confirm that the filter box 38 has been used. Further, the edge portions, which are disposed at the upper ends of the first groove 52a and the equivalent of the frame 50, are moved along the forward end portions (rotary bodies) of the shaft members 48A, 49A. Therefore, even when the weight of the filter box 38 is large, the filter box 38 can be easily pushed and inserted into the casing 28.

After that, as shown in FIG. 5C, the second groove 52b of the filter box 38 arrives at the shaft member 48A, and then the shaft member 48A is relatively moved with respect to the frame 50 along the second groove 52b by the self-weight of the filter box 38 so that the filter box 38 is lowered to be placed on the upper surface of the partition plate 42A, as shown by an arrow B3. As a result, as shown in FIG. 5D, the filter box 38 is placed on the partition plate 42A in a state that the shaft members 48A, 49A are stopped at the intermediate positions of the second groove 52b and the equivalent of the guide grooves 52, 53. Accordingly, the filter box 38 is placed stably in a state that the filter box 38 is correctly positioned in the X-Y direction to cover the opening 42Aa of the partition plate 42A therewith.

Further, owing to the presence of the second tapered portion 52d, the first groove 52a can be easily guided and engaged with the shaft member 48A. Further, owing to the presence of the first tapered portion 52c, the second groove 52b can be easily engaged with the shaft member 48A next to the first groove 52a of the guide groove 52. By the first tapered portion 52c, the operator is enabled to easily grasp the position of the second guide groove 52b, consequently the position of the install position (arrangement position) in the inserting direction (X-direction) of the filter box 38.

The other filter boxes 38 shown in FIG. 2 can be also placed on the upper surface of the filter box 38 or the upper surface of the partition plate 42C in the same manner as described above.

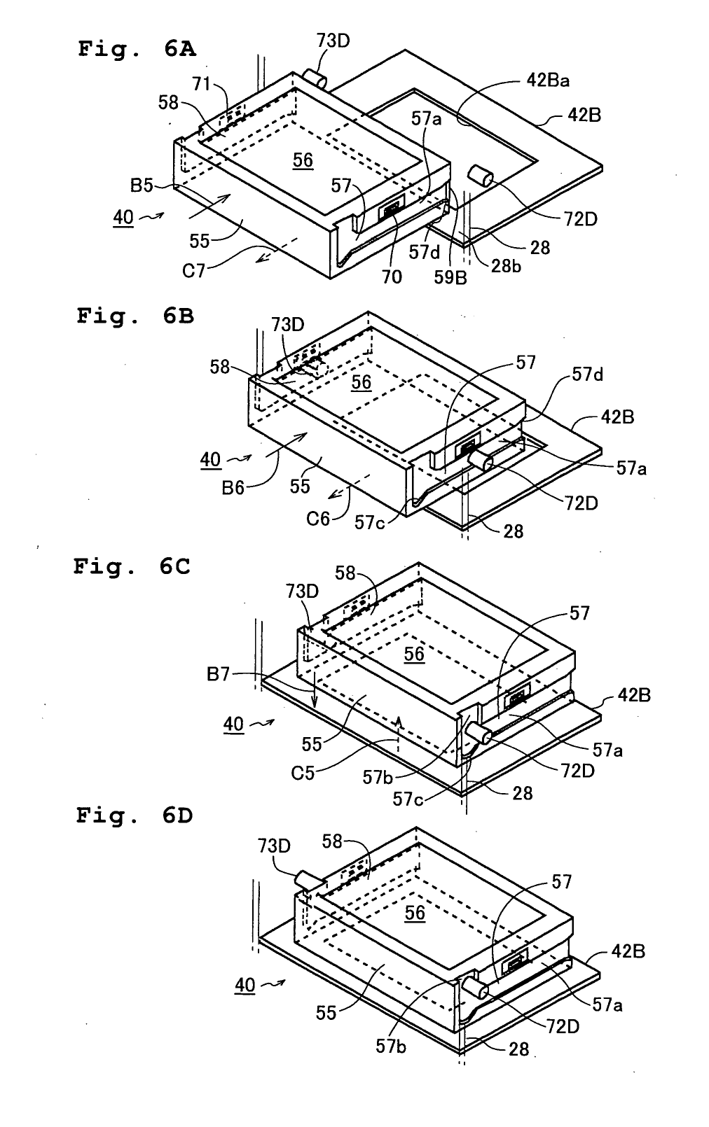

On the other hand, in a case that the filter box 40 shown in FIG. 4C is installed or arranged on the upper surface of the partition plate 42B of the casing 28 shown in FIG. 2, as shown in FIG. 6A, the operator holds the filter box 40 via the grip portions 70, 71 of the frame 55. In this state, the operator moves the first groove 57a and the equivalent of the guide grooves 57, 58 of the filter box 40 (frame 55) to the positions located in front of the pair of shaft members 72D, 73D of the casing 28. In an unused filter box 40, a thin film 59B is provided in a stretched form at the inlet of the first groove 57a so that the thin film 59B can be exfoliated. The filter box 40 is pushed and inserted into the casing 28 via the window 28b as shown by an arrow B5 to engage the first groove 57a with the shaft member 72D, and thus the film 59B is exfoliated.

Subsequently, as shown by an arrow B6 in FIG. 6B, the filter box 40 is further slidably pushed and inserted. By doing so, as shown in FIG. 6C, the second groove 57b of the filter box 40 arrives at the shaft member 72D. Also in this case, the edge portions, which are disposed at the upper ends of the first groove 57a and the equivalent of the frame 55, are moved along the forward end portions (rotary bodies) of the shaft members 72D, 73D. Therefore, even when the weight of the filter box 40 is large, the filter box 40 can be easily pushed and inserted into the casing 28. After that, the shaft member 72D is relatively moved with respect to the frame 55 along the second groove 57b so that the filter box 40 is placed on the upper surface of the partition plate 42B, as shown by an arrow B7. As a result, as shown in FIG. 6D, the filter box 40 is placed on the partition plate 42B in a state that the shaft members 72D, 73D are positioned at substantially intermediate positions of the second groove 57b and the equivalent of the guide grooves 57, 58. Accordingly, the filter box 40 is placed stably in a state that the filter box 40 is correctly positioned in the X-Y direction to cover the opening 42Ba of the partition plate 42B therewith.

The remaining filter boxes 40 shown in FIG. 2 can be also placed on the upper surfaces of the other filter boxes 40 in the same manner as described above. After that, the door 29 shown in FIG. 2 is closed, and thus the filter apparatus 26 can now be used. The clean air, which is allowed to pass through the filter apparatus 26, can be supplied into the chamber 10 of the exposure apparatus EX.

Next, in a case that the filter boxes 38, 40 of the filter apparatus 26 are exchanged, the door 29 of the casing 28 is opened. The upper stage filter boxes 38 placed or disposed on the middle stage filter boxes 40 are unloaded from above the middle stage filter boxes 40. After that, the middle stage filter boxes 40 placed on the lower stage filter boxes 38 are unloaded from above the lower stage filter boxes 38. Finally, the lower stage filter boxes 38 placed or disposed on the partition plate 42A are unloaded from the partition plate 42A. The operations for unloading the filter boxes of the upper stage, the middle stage, and the lower stage are same with each other. Therefore, the unloading operation will be specifically explained below as exemplified by an exemplary case in which the lower stage filter box 38 is unloaded from the partition plate.

A case is conceived in which after the upper stage filter boxes 38 and the middle stage filter boxes 40 are unloaded and two of the lower stage filter boxes 38 are unloaded, the remaining, lowermost filter box 38 of the lower stage filter boxes 38 is unloaded from the partition plate 42A. In this case, the operator grips the grip portions 70, 71 of the filter box 38 by the hands, and the operator lifts (uplifts) the filter box 38 upwardly so that the shaft member 48A is relatively moved with respect to the frame 50 slidably along the second groove 52b of the guide groove 52 as shown by an arrow C1 in FIG. 5C. Then, after the first tapered portion 52c of the guide groove 52 arrives at the shaft member 48A, the operator pulls and extracts the filter box 38 in the frontward direction (in the direction directed toward the front surface of the filter box 38) so that the shaft member 48A is relatively moved with respect to the frame 50 slidably along the first groove 52a as shown by an arrow C2 in FIG. 5B. Also in this case, the weight of the filter box 38 is supported by the shaft members 48A, 49A. Therefore, the filter box 38 can be easily pulled and extracted. After that, as shown by an arrow C3 in FIG. 5A, the filter box 38 is further pulled and extracted in the frontward direction in relation to the casing 28, and thus the filter box 38 can be unloaded. In this procedure, owing to the presence of the first tapered portion 52c of the guide groove 52, the movement can be performed smoothly from the second groove 52b to the first groove 52a of the guide groove 52 along the shaft member 48A.

Similarly, the other filter boxes 38 can also be unloaded easily. After that, when an unused filter box 38 is installed or arranged in the casing 28, the operation shown in FIGS. 5A to 5D may be repeated.

Further, for example, when the filter box 40 is unloaded from the upper surface of the partition plate 42B, the operator grips the grip portions 70, 71 of the filter box 40 by the hands, and lifts the filter box 40 upwardly so that the shaft member 72D is relatively moved with respect to the frame 55 slidably along the second groove 57b of the guide groove 57 as shown by an arrow C5 in FIG. 6C. Then, after the first tapered portion 57c of the guide groove 57 arrives at the shaft member 72D, the operator pulls and extracts the filter box 40 in the frontward direction so that the shaft member 72D is relatively moved with respect to the frame 55 slidably along the first groove 57a as shown by an arrow C6 in FIG. 6B. Also in this case, the weight of the filter box 40 is supported by the shaft members 72D, 73D. Therefore, the filter box 40 can be easily pulled and extracted. After that, as shown by an arrow C7 in FIG. 6A, the operator further pulls and extracts the filter box 40 in the frontward direction in relation to the casing 28, and thus the filter box 40 can be unloaded.

Similarly, the other filter boxes 40 can also be easily unloaded. After that, when an the unused filter box 40 is installed or arranged in the casing 28, the operation shown in FIG. 6A to FIG. 6D may be repeated.

The effects, etc. of this embodiment are as follows.

(1) The exposure apparatus EX of this embodiment is provided with the overall air-conditioning system including the filter apparatus 26 and the air-conditioning apparatus 30; and the filter apparatus 26 is provided with the plurality of filter boxes which hold the plurality of chemical filters including the chemical filter 51 (first filter) and the chemical filter 56 (second filter). Namely, the filter boxes include the first filter box 38 having the box-shaped first frame 50 which holds the chemical filter 51 and which is provided with the guide grooves (first protrusion/recess-formed portions) 52, 53 provided on the pair of side surfaces 50c, 50d of the frame 50; and the second filter box 40 having the box-shaped second frame 55 which holds the chemical filter 56, which has the guide grooves (second protrusion/recess-formed portions) 57, 58 provided on the pair of side surfaces 55c, 55d of the frame 55, and which is arranged in the casing 28 (container). Further, the guide groove 52 of the frame 50 has the first groove (first recess) 52a which is communicated with the back surface 50b of the frame 50, and the second groove (second recess) 52b which is communicated with the first groove 52a and which extends toward the upper end of the frame 50; the guide groove 57 of the frame 55 has the first groove (third recess) 57a which is communicated with the back surface 55b of the frame 55, and the second groove (fourth recess) 57b which is communicated with the first groove 57a and which extends toward the upper end of the frame 55; and the width of the first and second grooves 52a, 52b and the width of the first and second grooves 57a, 57b are different from each other.

Further, the filter apparatus 26 of the embodiment is provided with the accommodating box (accommodating section) 27 which accommodates the first and second filter boxes 38, 40 and the frames 50, 55 of the filter boxes 38, 40. Furthermore, the accommodating box 27 has the columnar shaft members 48A to 48C, 48G to 48I (first engaging portions) each of which engages with the first groove 52a of the frame 50 to support the frame 50 and each of which engages with the second groove 52b of the frame 50 to release the frame 50 from being supported, and the columnar shaft members 72D to 72F (second engaging portions) each of which engages with the first groove 57a of the frame 55 to support the frame 55 and each of which engages with the second groove 57b of the frame 55 to release the frame 55 from being supported.

According to the embodiment, by providing the shaft members 48A, etc. and the shaft members 72D, etc. on the side of the casing 28 accommodating the frames 50 and 55 and by moving the frames 50, 55 while guiding the frames 50, 55 so that the shaft members 48A, 72D, etc. are relatively moved with respect to frames 50, 55 along the guide grooves 52, 57, etc. of the frames 50, 55 respectively, the frames 50, 55 can be efficiently installed to the casing 28 and the positioning of the frames 50, 55 can be easily performed. Further, by moving the frames 50, 55 in the opposite direction, the frames 50, 55 can be efficiently unloaded from the casing 28. Accordingly, it is possible to efficiently exchange the plurality of filter boxes 38, 41 (and consequently the chemical filters 51, 56) in the casing 28.

Further, the width a1 of the first and second grooves 52a, 52b of the guide groove 52 of the frame 50 is different from the width b1 of the first and second grooves 57a, 57b of the guide groove 57 of the frame 55; in this embodiment, the width b1 is made to be greater with respect to the width a1. According to this, the diameter φD of the forward end portion of the shaft member 72D, etc. which engages with the guide groove 57 is formed to be greater than the diameter φA of the forward end portion of the shaft member 48A, etc. which engages with the guide groove 52. Thus, by the operator's sight or sense, it is possible to prevent, in the casing 28, the frame 50 (filter box 38) from being installed erroneously at the position to which the frame 55 (filter box 40) is to be installed, and to prevent the frame 55 from being installed erroneously at the position to which the frame 50 is to be installed. In particular, when the diameter φD of the forward end portion of the shaft member 72D is greater than the width a1 of the first groove 52a (and the second groove 52b) of the guide groove 52, it is possible to physically prevent the frame 50 from being erroneously installed at the position at which the frame 55 is to be installed.

(2) Further, the shapes of the guide grooves 52, 53 formed on the pair of side surfaces of the frame 50 are symmetrical; and the shapes of the guide grooves 57, 58 formed on the pair of side surfaces of the frame 55 are symmetrical. Furthermore, the shaft member 48A, etc. and the shaft members 49A, etc. are fixed in the casing 28 so that the shaft member 48A, 49A, etc. face or are opposite to the guide grooves 52, 53 corresponding thereto; and the shaft members 72D to 72F and 73D to 73F are fixed in the casing 28 so that the shaft member 72D to 72F and 73D to 73F face or are opposite to the guide grooves 57, 58 corresponding thereto. Accordingly, it is possible to install and remove the frame 50 (filter box 38) with respect to the casing 28 in a short period of time and with efficiency, and to install and remove the frame 55 (filter box 40) with respect to the casing 28 in a short period of time and with efficiency.

Note that the guide grooves 52, 53 of the frame 50 may be formed substantially symmetrically and that the guide grooves 57, 58 of the frame 55 may be formed substantially symmetrically.

It is also allowable that the guide groove 52 is formed on only one side surface of the frame 50; that the guide groove 57 is formed on only one side surface of the frame 55; and that the other surface facing or opposite to the one surface of each of the frames 50 and 55 is made as a flat surface. In this case, it is allowable that only the shaft members 48A to 48C, 48G to 48I and 72D to 72F are fixed in the casing 28. Further, the frames 50, 55 are moved so that the guide grooves 52, 57 each as one of the grooves are moved relative to and along for example the shaft members 48A, 72D, respectively. By doing so, each of the frames 50, 55 can be arranged or placed in the casing 28 relatively easily and further, each of the frames 50, 55 can be easily unloaded from the casing 28.

(3) Further, the filter box 38 (frame 50) and the filter box 40 (frame 55) are arranged in the casing 28 while being overlapped with each other.

Note that the phrase “the frame 50 and the frame 55 are arranged in the casing 28 while being overlapped with each other” also means that the frame 50 and the frame 55 are arranged along the flow of the gas to be subjected to the filtration. With this, it is possible to efficiently remove any impurity from the gas.

(4) The guide grooves 52, 57 of the frames 50, 55 have the first tapered portions 52c, 57c which are formed at the positions of communication between the first grooves 52a, 57a and the second grooves 52b, 57b and which have the widths gradually narrowed toward the back surfaces of the frames 50, 55, respectively. Therefore, the shaft members 49A, 73D, etc. can be relatively moved smoothly with respect to the guide grooves 52, 57.

It is not necessarily indispensable that the first tapered portions 52c, 57c are provided.

(5) Further, the guide grooves 52, 57 have the second tapered portions 52d, 57d which are formed at the portions of communication with the back surfaces of the first grooves 52a, 57a and which have the widths gradually widened toward the back surfaces, respectively. Therefore, the first grooves 52a, 57a can be easily engaged with the shaft members 48A, 72D, etc. The second tapered portions 52d, 57d can be also omitted.

(6) Furthermore, the grip portions 70 (fifth recesses) are provided between the upper ends of the frames 50, 55 and the first grooves 52a, 57a of the frames 50, 55. Therefore, the operator can transport the frames 50, 55 (filter boxes 38, 40) with ease. The grip portions 70 may be provided on only one side of the frames 50, 55, respectively. Alternatively, for example, by making the side surfaces 50c, 50d and 55c, 55d of the frames 50, 55 be rough surfaces, it is also possible to omit the grip portions 70.

(7) Moreover, portions, of the shaft members 48A and 72D, which are brought into contact with (which are engaged with) the guide grooves 52 and 57 of the frames 50 and 55, respectively are supported via the rotary bearings 48Ad, etc., and thus it is possible to move the frames 50 and 55 quite smoothly. Note that by satisfactorily smoothing the surfaces of the front end portions of the shaft members 48A and 72D, it is also possible to omit the rotary bearing and the rotary body from the forward end portion of each of the shaft members 48A and 72D.

(8) The films 59A, 59B are provided at the inlets of the first grooves 52a, 57a of the frames 50, 55 so that the films 59A, 59B can be exfoliated. Therefore, it is possible to easily confirm whether the chemical filters in the frames 50, 55 have been used or unused.

Note that without being limited to this construction, it is also allowable to determine or discriminate whether or not the chemical filter in the filter box have been used or unused based on presence or absence of any cut or breakage in the film. Further, the films 59A, 59B may be provided beforehand at any portions of the first grooves 52a, 57a and the second grooves 52b, 57b. Whether or not the chemical filters have been used may be also confirmed by any other method (for example, a method in which the operator exfoliates a label) without providing the films 59A, 59B for the frames 50, 55.

(9) The chemical filter 51 (filter medium) in the frame 50 removes the organic gas (organic matter) contained in the gas passing therethrough, and the chemical filter 56 (filter medium) in the frame 55 removes the alkaline gas and the acid gas contained in the gas passing therethrough. Therefore, the air, from which the impurities have been removed to a high extent, can be supplied into the chamber 10 in which the exposure apparatus-body section 4 is accommodated.

(10) The exposure apparatus EX of this embodiment is the exposure apparatus which exposes the wafer W (substrate) with the exposure light EL via the pattern of the reticle R and the projection optical system PL, the exposure apparatus EX including the chamber 10 accommodating the exposure apparatus-body section 4 which exposes the wafer W; the filter apparatus 26 of this embodiment; and the air-conditioning apparatus 30 which feeds the air taken in from the outside of the chamber 10 to the inside of the chamber 10 via the filter apparatus 26.

According to this embodiment, the filter box 38 (chemical filter 51) and the filter box 40 (chemical filter 56) can be installed and exchanged efficiently; and the positioning can be performed highly accurately between the frames 50, 55 of the filter boxes 38, 40. Therefore, the maintenance can be performed efficiently for the exposure apparatus, and it is possible to highly accurately remove the impurities of the air in the chamber 10.

In this embodiment, frames, which are formed with the same or equivalent guide grooves as those of the frames 50, 55 of the filter boxes 38, 40, may be also used as the frames for the filter boxes 63, 64 of the local air-conditioning apparatus 60 in the loader chamber 10b, and the filter boxes 63, 64 may be also accommodated in a casing provided with shaft members 48A, 49A, 72D, 73D, etc., in a similar manner with respect to the casing 28.

In the embodiment, the diameter φD of the forward end portion of the shaft member 72D is greater than the diameter φA of the forward end portion of the shaft member 48A, and the diameter φD of the forward end portion of the shaft member 72D is greater than the width a1 of the grooves 52a, 52b of the guide groove 52 (φA<a1<φD). With this, the forward end portion of the shaft member 72D is not allowed to pass or move in the guide groove 52 (grooves 52a, 52b) of the frame 50. However, it is not necessarily indispensable that the diameter φD of the forward end portion of the shaft member 72D is made to be greater than the width a1 of the groove 52a (52b) of the guide groove 52. By making the diameter φD of the forward end portion of the shaft member 72D be greater than the diameter φA of the forward end portion of the shaft member 48A and by making the width b1 of the groove 57a (57b) of the guide groove 57 be greater than the width a1 of the groove 52a (52b) of the guide groove 52, it is possible, depending on the operator's sight or sense, to prevent the frame 50 (filter box 38) from being installed erroneously at the position to which the frame 55 (filter box 40) is to be installed, and to prevent the frame 55 from being installed erroneously at the position to which the frame 50 is to be installed. In this case, the relationship (ratio or difference) between the diameter φA of the forward end portion of the shaft member 48A and the width a1 of the groove 52a (52b) of the guide groove 52 and the relationship (ratio or difference) between the diameter φD of the forward end portion of the shaft member 72D and the width b1 of the groove 57a (57b) of the guide groove 57 may be substantially same with each other.

### Second Embodiment

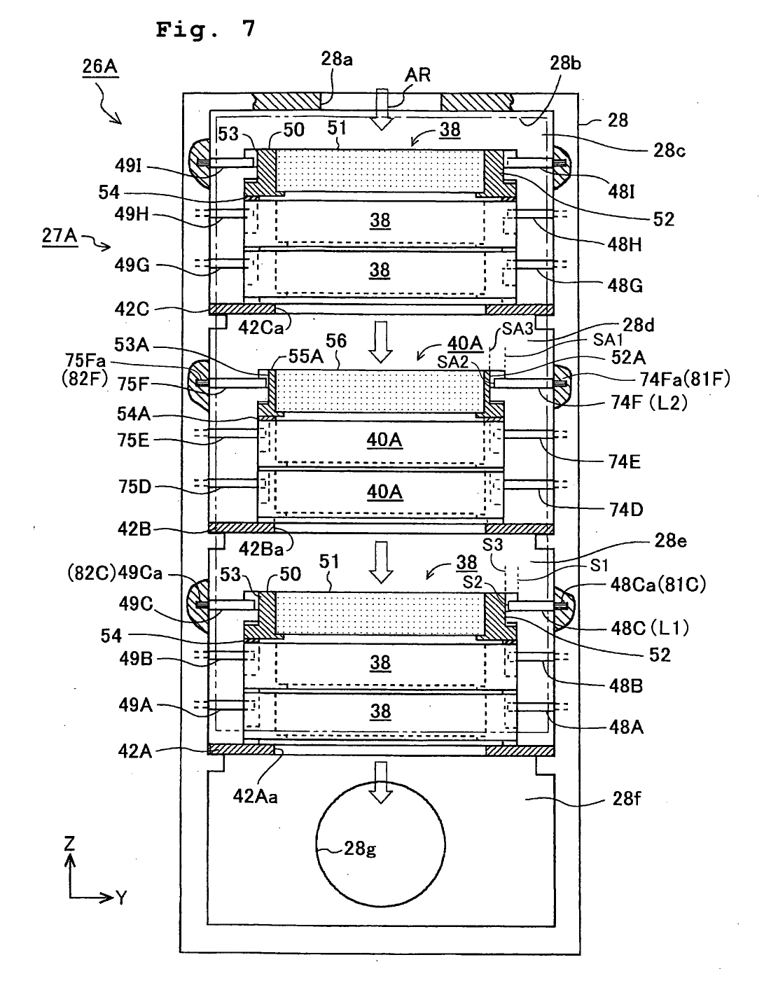

Next, a second embodiment will be explained with reference to FIG. 7. In this embodiment, the width of the frame and the shape (depth) of guide grooves (protrusion/recess-formed portion) of a predetermined filter box of the filter apparatus provided on the exposure apparatus are changed. In the following description, the components or parts, which correspond to those shown in FIG. 3A, are designated by the same reference numerals in FIG. 7, any detailed explanation of which will be omitted.

FIG. 7 shows, with partial cutaway, a casing 28 of an accommodating box 27A of a filter apparatus 26A of the second embodiment, as viewed from the front side (forward side) thereof. In FIG. 7, three stages of first filter boxes 38 holding chemical filters 51 respectively are installed and placed on each of partition plates 42A and 42C which are the upper and lower partition plates in the casing 28; and three stages of second filter boxes 40A holding chemical filters 56 respectively are installed and placed on a partition plate 42B which is the middle or center partition plate in the casing 28. Shaft members 48A to 48C and 49A to 49C (first engaging portions) which engage with guide grooves 52 and 53 (first protrusion/recess-formed portions) formed on a pair of side surfaces of the frame 50 of each of the filter boxes 38 on the partition plates 42A (42C) are detachably fixed to the inner surface of the casing 28.

Further, the second filter boxes 40A on the partition plate 42B each have a boxed-shaped frame 55A holding the chemical filter 56 and each have openings on upper and lower sides thereof. The width in the Y direction of the frame 55A is narrower than the width in the Y direction of the frame 50; and the frame 55A is provided with guide grooves 52A, 53A (second protrusion/recess-formed portions) which are symmetrically formed on a pair of side surfaces in the Y direction of the frame 55A and which have a same shape as that of the guide grooves 52, 53. Each of the guide grooves 52A, 53A has a first groove (third recess) and a second groove (fourth recess) connected to each other. A rectangular frame-shaped gasket 54A is fixed on the bottom surface of the frame 55A. The gasket 54A is smaller than the basket 54 fixed to the bottom surface of the frame 50. Here, in the side surface in the +Y direction of the frame 50 of the filter box 38, a surface surrounding the guide groove 52 is referred to as an outer surface S1, and a recessed surface in the guide groove 52 is referred to as an inner surface S3; and in the side surface in the +Y direction of the frame 55 of the filter box 40A, a surface surrounding the guide groove 52A is referred to as an outer surface SA1, and a recessed surface in the guide groove 52A is referred to as an inner surface SA3.

In this embodiment, the centers of the frames 50 and 55A are each on a same straight line which is parallel to the Z axis, the outer surface SA1 of the frame 55A is on the inner side (on the side of the −Y direction) with respect to the inner surface S3 of the guide groove 52 of the frame 50. At this time, since the inner surface SA3 of the guide groove 52A of the frame 55A is on the inner side with respect to the inner surface S3 of the guide groove 52 of the frame 50, it is possible to consider that the guide groove 52A is deeper than the guide groove 52. Similarly, it is also possible to consider that the guide groove 53A as the other groove (on the other side) of the frame 55A is deeper than the guide groove 53 of the frame 50. The difference between a depth DA of the guide grooves 52A, 53A (here, a spacing distance between the outer surface SA1 and the inner surface SA3) and a depth DB of the guide grooves 52, 53 (here, a spacing distance between the outer surface S1 and the inner surface S3) can be set to be not less than 10 mm, preferably to be not less than 20 mm.

Shaft members 74D to 74F and shaft members 75D to 75F (second engaging portions), which have a same shape to one another and which engage with the guide grooves 52A, 53A formed on the pair of side surfaces of the frame 55A of each of the three stages of filter boxes 40A on the partition plate 42B, are fixed to the inner surface of the casing 28. The shaft members 74F, 75F have screw portions 74Fa, 75Fa respectively which are detachably fixed to screw holes 81F, 82F, respectively, of the casing 28; similarly, the other shaft members 74D, 75D, etc. are also detachably fixed to the casing 28 by means of screw clamping (screw fastening or attaching). Forward end portions, of the shaft members 74D, 75D, etc., which engage with the guide grooves 52A, 53A are rotatably supported via rotary bearings (not shown). Note that the rotary bearings can be omitted.

Further, a forward end surface S2 of the shaft member 48C is located between the outer surface S1 of the frame 50 and the inner surface S3 of the guide groove 52, and a forward end surface SA2 of the shaft member 74F is located between the outer surface SA1 of the frame 55A and the inner surface SA3 of the guide groove 52A. In this case, since the outer surface SA1 of the frame 55A is on the inner side with respect to the inner surface S3 of the frame 50, a length L2 of the shaft member 74F (74D, 74E) which engages with the guide groove 52A of the frame 55A is longer than a length L1 of the shaft member 48C (48A) of the frame 50 which engages with the guide groove 52 of the frame 50. Similarly, the shaft members 75D to 75F each of which engages with the guide groove 53A, as the other guide groove (on the other side) of the frame 55A, are also longer than the shaft member 49C. In particular, it is preferable that the length (L1) of the shaft members 48A to 48C and 49A to 49C which are fixed to the casing 28 is adjusted (shortened) with respect to the length (L2) of the shaft members 74D to 74F and 75D to 75F such that the shaft members 48A, 49A cannot engage with the guide grooves 52A, 53A of the frame 55A at the same time when an attempt is made to install or place the filter box 40A (frame 55A) at a predetermined position at which the filter box 38 (frame 50) is to be installed (on the partition plate 42A) and/or at least one of the shaft members 74D, 75D cannot pass through or move in (cannot engage with) the guide grooves 52, 53 when an attempt is made to install or place the filter box 38 (frame 50) at a predetermined position at which the filter box 40A (frame 55A) is to be installed or placed (on the center partition plate 42B).

Note that the difference between the length (L1) of the shaft members 48A to 48C and 49A to 49C and the length (L2) of the shaft members 74D to 74F and 75D to 75F can be adjusted to be not less than 10 mm, preferably to be not less than 20 mm considering a spacing distance between the inner wall surface of the casing 28 and the side surfaces of the filter boxes 38, 40 for accommodating the filter boxes 38, 40 inside the casing 28. This configuration is similar to that of the first embodiment.

The effects, etc. of this embodiment are as follows.

(1) According to the filter boxes 38, 40A or the filter apparatus 26A of the second embodiment, the shaft members 48A, etc. and the shaft members 74D, etc. are provided on the side of the casing 28 which accommodates the frames 50, 55A. Further, by moving the frames 50, 55A such that the shaft members 48A, 74D, etc. are relatively moved along the guide grooves 52, 52A of the frames 50, 55A, respectively, it is possible to efficiently install and easily position the frames 50, 55A with respect to the casing 28. Further, by moving the frames 50, 55A in the reverse or opposite direction (to the direction during the installment and positioning of the frames 50, 55A), the frames 50, 55A can be efficiently unloaded from the casing 28. Accordingly, the plurality of filter boxes 38, 40A (and consequently the chemical filters 51, 56) inside the casing 28 can be exchanged efficiently.

(2) Further, the pair of side walls, of the frame 55A of the filter box 40A of the filter apparatus 26A, in which the guide grooves 52A, 53A are formed have a width narrower than the width of the pair of side walls, of the frame 50 of the filter box 38, in which the guide grooves 52, 53 are formed; and the guide grooves 52A, 53A can be considered as being deeper than the guide grooves 52, 53. Accordingly, the filter box 38 (chemical filter 51) and the filter box 40A (chemical filter 56) can be easily distinguished from each other based on the outer appearances thereof.

(3) Furthermore, the length L1 of the shaft member 48A to 48C, 49A to 49C which are fixed to the casing 28 is adjusted to have the above-described desirable length (is made to be shorter) with respect to the length L2 of the shaft member 74D to 74F, 75D to 75F. By doing so, even when an attempt is made to install the filter box 40A (frame 55A) on the partition plate 42A, the shaft members 48A, 49A cannot engage with the guide grooves 52A, 53A of the frame 55A at the same time; and thus it is possible to prevent the filter box 40A from being erroneously installed on the partition plate 42A. On the contrary, when an attempt is made to install the filter box 38 (frame 50) on the center partition plate 42B, at least one of the shaft members 74D, 75D cannot pass through (move in) the guide grooves 52, 53; and thus it is possible to prevent the filter box 38 from being erroneously installed or placed on the partition plate 42B.

In this embodiment, the following modifications can be made.

(1) It is allowable that the width in the Y direction of the frame 55A of the filter box 40A is made to be same as the width in the Y direction of the frame 50 of the filter box 38, and that the guide grooves 52A, 53A formed on the pair of side surfaces in the Y direction of the frame 55A are processed so that the guide grooves 52A, 53A have a depth that is as deep as the inner surface SA3. In this case, even when the shaft members 74A, 75D are used as they are, the filter box 40A can be moved smoothly along the shaft members 74D, 75D and the filter boxes 38 and 40A are distinguishable easily from each other based on the outer appearances thereof.

(2) It is allowable to form, in the pair of side surfaces of the frame 55A of the filter box 40A, guide grooves having a large width and a same shape as that of the guide grooves 57, 58 (protrusion/recess-formed portions) formed in the frame 55 of the filter box 40 shown in FIG. 2. In this case, shaft members each having a same length as that of the shaft members 74D, 75D and each having a forward end portion of which diameter is same as that of the shaft members 72D, 73D shown in FIG. 2 are fixed to the casing 28, instead of the shaft members 74D to 74F, 75D to 75F in the middle stage shown in FIG. 7. By doing so, it is possible to easily install and unload the filter box 40A with respect to the casing 28.

Further, in the first and second embodiments, the following modifications can be made.

In each of the first and second embodiments, in a case that a portion, of the side surface of the frame 50, which is different from the guide grooves 52, 53 (protrusion/recess-formed portions) is considered as a protrusion portion (protrusion-formed portion), then such a protrusion portion may be formed of a separate member. The frames 55, 55A other than the frame 50 may also be constructed in a similar manner as described above.

Furthermore, although the six stages of the frames 50 (filter boxes 38) and the three stages of the frames 55, 55A (filter boxes 40, 40A) are arranged on the filter apparatuses 26, 26A of the respective embodiments, the number of the installed filter boxes 38 is arbitrary, and the number of the installed filter boxes 40, 40A is also arbitrary.

Moreover, the casing 28 of each of the filter apparatuses 26, 26A is partitioned into a plurality of spaces by the partition plates 42A to 42C. However, it is also possible, for example, to merely stack the frames 50 and 55 (55A) (filter boxes 38 and 40 (40A) alternately, without partitioning the inside of the casing 28 by the partition plates 42A to 42C.

Note that the chemical filter 56 inside the frame 55, 55A may be, for example, a filter which removes at least one of an alkaline substance and an acid substance contained in a gas passing through the chemical filter 56.

Further, it is allowable to use, as the filters in the frames 50, 55, 55A, any filter (filter medium or filter material) which is different from the chemical filter. For example, it is also possible to use, as the filter inside the frame 50, 55, 55A, a dustproof filter or dust-preventive filter such as HEPA filter or ULPA filter or the like which removes minute particles (fine particles).

Furthermore, in the embodiments described above, an example is shown in which the second grooves 52b, 57b are formed to penetrate up to (penetrate to arrive at) the upper ends of the frames 50, 55, respectively. However, it is allowable that the second grooves 52b, 57b may be formed up to a position in front of (not arriving to) the upper ends of the frames 50, 55, respectively. In this case, the upper end of each of the second grooves 52b, 57b has a holding or stopping portion. By doing so, in a case that the user inadvertently makes a mistake regarding the installation position of the filter box in the up and down direction, it is possible to avoid the hand(s) of the user from being affected by a sudden load, owing to the presence of the holding portion at the upper end of the second groove 52b, 57b.

In the embodiments, the groove having a specific shape and the protrusion/recess-formed portion having a specific shape are shown by the drawings. However, the groove and the protrusion/recess-formed portion are not limited to the exemplified specific shapes, and may be formed to have any shapes. With respect to the shaft member, the shape of the shaft member is not limited to the columnar shape shown in the embodiments; and it is allowable to use shaft members having various shapes such as quadrangular prism shape, etc.

In the embodiments described above, the filter boxes 38 and 40 are respectively installed or charged in the casing 28 at appropriate positions one by one. It is allowable, however, to install a plurality of filter boxes such as two pieces or three pieces of the filter boxes in the casing 28 at the same time while stacking or overlaying (overlapping) the filter boxes. In such a case, it is allowable for example that among two pieces (or three pieces) of the filter boxes, a filter box or filter boxes is/are previously positioned with respect to and arranged on a lowermost filter box among the filter boxes which is located at the lowermost position, and then these filter boxes are installed or charged in the casing 28. In this case, when only the filter box located at the lowermost position among the stacked filter boxes is engaged with the corresponding shaft member(s) and is installed in the casing 28 at the appropriate position, then consequently all the stacked filter boxes are automatically positioned. Therefore, in such a case, it is sufficient that only the shaft member corresponding to the filter box located at the lowermost position among the stacked filter boxes is provided, and there is no need to provide another shaft member or members. For example, in a case that three filter box 38 are stacked or overlaid and installed at the same time in the first space 28c of the casing 28, only the shaft member 48G or/and the shaft member 49G is/are provided, and there is no need to use the shaft members 48H, 48I, 49H and 49I. In this case, there is no need to form the first groove and the second groove on the both side surfaces of the frame 50 of each of the middle and upper stage filter boxes 38 among the stacked filter boxes 38.

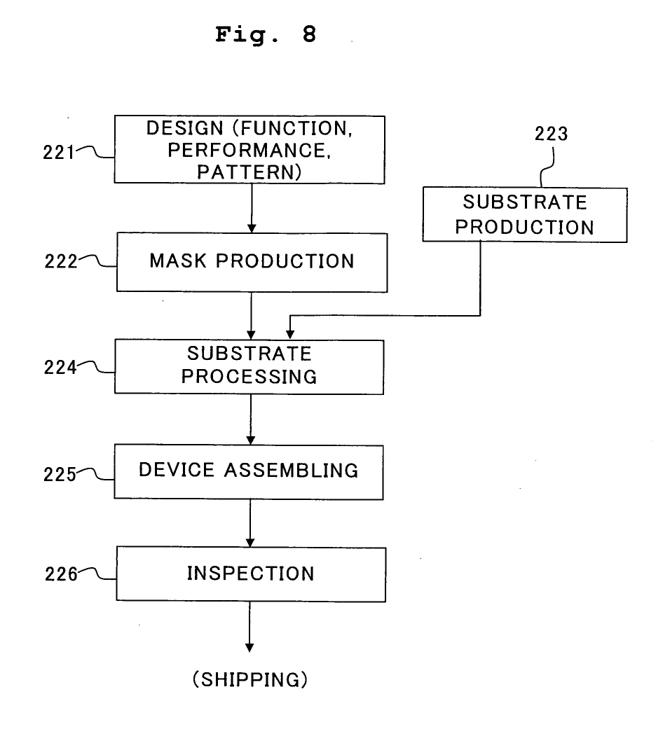

In a case that an electronic device (or a microdevice) such as a semiconductor device or the like is produced by using the exposure apparatus EX of the embodiment described above, as shown in FIG. 8, the electronic device is produced by performing a step 221 of designing the function and the performance of the electronic device; a step 222 of manufacturing a mask (reticle) based on the designing step; a step 223 of producing a substrate (wafer) as a base material for the device and coating the substrate (wafer) with a resist; a substrate-processing step 224 including, for example, a step of exposing the substrate (photosensitive substrate) with the pattern of the mask by the exposure apparatus of the embodiment described above, a step of developing the exposed substrate, and a step of heating (curing) and etching the developed substrate; a step 225 of assembling the device (including processing processes such as a dicing step, a bonding step, and a packaging step); an inspection step 226; and the like.

Therefore, the method for producing the device includes forming a pattern of a photosensitive layer on the substrate by using the exposure apparatus of the embodiment described above, and processing the substrate formed with the pattern (Step 224). With the exposure apparatus, it is possible to reduce the maintenance cost, and it is possible to improve the exposure accuracy. Therefore, it is possible to produce the electronic device inexpensively and highly accurately.

In the embodiments described above, the air is used as the gas for the air-conditioning. In place of the air, it is also allowable to use, for example, nitrogen gas, noble gas or rare gas (helium, neon, etc.), or a mixed gas of the above-described gases.

The present invention is also applicable to a case that the exposure is performed by using a projection exposure apparatus of the full field exposure type (stepper type), without being limited to only the projection exposure apparatus of the scanning exposure type.

The present invention is also applicable when the exposure is performed by using, for example, an exposure apparatus of the proximity system or the contact system in which any projection optical system is not used.

The present invention is not limited to the application to the process for producing the semiconductor device. The present invention is also widely applicable, for example, to the process for producing a display apparatus including a liquid crystal display element formed on a square or rectangular glass plate, a plasma display, etc., and the process for producing various devices including an image pickup element (CCD, etc.), a micromachine, MEMS (Microelectromechanical Systems), a thin film magnetic head, a DNA chip, etc. Further, the present invention is also applicable to the production step when a mask (a photomask, a reticle, etc.), on which mask patterns for various devices are formed, is produced by using the photolithography step.

As described above, it is a matter of course that the present invention is not limited to the embodiments described above, which may be embodied in other various forms within a scope without deviating from the gist or essential characteristics of the present invention.

According to the above-described aspect, for example, the first protrusion (first engaging portion) and the second protrusion (second engaging portion) are provided on the side of the accommodating section which accommodates the first and second frames; and the first frame and the second frame are moved such that the first protrusion and the second protrusion are moved relative to the first frame and the second frame along the first protrusion/recess-formed portion of the first frame and the second protrusion/recess-formed portion of the second frame, respectively. By doing so, the first and second frames can be efficiently installed and easily positioned with respect to the accommodating section. Further, it is possible to efficiently unload the first and second frames from the accommodating section. Therefore, it is possible to efficiently install or exchange the first and second filters which are held by the first and second frames (first and second filter boxes). Furthermore, the first recess and the second recess of the first frame and the third recess and the fourth recess of the second frame are different from each other in at least one of the width and the depth thereof. Accordingly, for example, in a case that the kinds (types) of the first and second filters are different from each other, it is possible to easily prevent these different kinds of filters (filter boxes) from being installed at wrong installation positions.

1. A plurality of filter boxes which hold a plurality of filters including a first filter and a second filter, the filter boxes comprising:
a first filter box having a box-shaped first frame which holds the first filter and which has a first protrusion/recess-formed portion provided on at least one side surface of the first frame; and
a second filter box having a box-shaped second frame which holds the second filter and which has a second protrusion/recess-formed portion provided on at least one side surface of the second frame;
wherein the first protrusion/recess-formed portion has a first recess which is arranged between an upper end and a lower end of the first frame and which is communicated with a side end of the at least one side surface of the first frame, and a second recess which is communicated with the first recess and which extends toward the upper end of the first frame;
the second protrusion/recess-formed portion has a third recess which is arranged between an upper end and a lower end of the second frame and which is communicated with a side end of the at least one side surface of the second frame, and a fourth recess which is communicated with the third recess and which extends toward the upper end of the second frame; and
the first and second recesses and the third and fourth recesses are different from each other at least in one of a width and a depth thereof.

2. The filter boxes according to claim 1, wherein the first and second recesses of the first protrusion/recess-formed portion and the third and fourth recesses of the second protrusion/recess-formed portion are different from each other in the width thereof.

3. The filter boxes according to claim 1, wherein the first and second recesses of the first protrusion/recess-formed portion and the third and fourth recesses of the second protrusion/recess-formed portion are different from each other in the depth thereof.

4. The filter boxes according to claim 3, wherein the first frame and the second frame are formed such that a width between a side surface provided with the first protrusion/recess-formed portion and another side surface facing the side surface is different from a width between a side surface provided with the second protrusion/recess-formed portion and another side surface facing the side surface.

5. The filter boxes according to claim 1, wherein the first protrusion/recess-formed portion is provided as first protrusion/recess-formed portions formed substantially symmetrically on a pair of side surfaces of the first frame; and the second protrusion/recess-formed portion is provided as second protrusion/recess-formed portions formed substantially symmetrically on a pair of side surfaces of the second frame.

6. The filter boxes according to claim 1, wherein fifth recesses are provided between the first recess of the at least one side surface of the first frame and the upper end of the first frame and between the third recess of the at least one side surface of the second frame and the upper end of the second frame, respectively.

7. The filter boxes according to claim 1, wherein the first filter box and the second filter box are arranged to be overlapped with each other.

8. The filter boxes according to claim 1, wherein the first filter and the second filter are chemical filters of mutually different types.

9. The filter boxes according to claim 1, wherein the first filter removes an organic matter contained in a gas passing through the first filter; and
the second filter removes at least one of an alkaline substance and an acid substance contained in a gas passing through the second filter.

10. A filter apparatus which accommodates a filter therein, the filter apparatus comprising:
the filter boxes as defined in claim 1; and
an accommodating section which accommodates the first frame and the second frame of the filter boxes;
wherein the accommodating section includes a first engaging portion which engages with the first recess of the first frame to support the first frame and which engages with the second recess of the first frame to release the first frame from being supported, and a second engaging portion which engages with the third recess of the second frame to support the second frame and which engages with the fourth recess of the second frame to release the second frame from being supported.

11. A filter apparatus which accommodates a filter therein, the filter apparatus comprising:
the filter boxes as defined in claim 2; and
an accommodating section which accommodates the first frame and the second frame of the filter boxes;
wherein the accommodating section includes a stick-shaped first engaging portion which engages with the first recess of the first frame to support the first frame and which engages with the second recess of the first frame to release the first frame from being supported, and a stick-shaped second engaging portion which engages with the third recess of the second frame to support the second frame and which engages with the fourth recess of the second frame to release the second frame from being supported, an outer diameter of the second engaging portion being different from an outer diameter of the first engaging portion.

12. The filter apparatus according to claim 11, wherein the width of the first and second recesses of the first protrusion/recess-formed portion is smaller than the width of the third and fourth recesses of the second protrusion/recess-formed portion;
the outer diameter of the first engaging portion is smaller than the outer diameter of the second engaging portion; and
the width of the first and second recesses is smaller than the outer diameter of the second engaging portion.

13. A filter apparatus which accommodates a filter therein, the filter apparatus comprising:
the filter boxes as defined in claim 3; and
an accommodating section which accommodates the first frame and the second frame of the filter boxes;
wherein the accommodating section includes a stick-shaped first engaging portion which engages with the first recess of the first frame to support the first frame and which engages with the second recess of the first frame to release the first frame from being supported, and a stick-shaped second engaging portion which engages with the third recess of the second frame to support the second frame and which engages with the fourth recess of the second frame to release the second frame from being supported, a length of the second engaging portion being different from a length of the first engaging portion.

14. The filter apparatus according to claim 13, wherein the first protrusion/recess-formed portion is provided as first protrusion/recess-formed portions formed on both side surfaces of the first frame, respectively, the second protrusion/recess-formed portion is provided as second protrusion/recess-formed portions formed on both side surfaces of the second frame, respectively, and the first engaging portion and the second engaging portion are provided in the accommodating section as a pair of first engaging portions and a pair of second engaging portions, respectively; and
the length of the pair of second engaging portions is adjusted with respect to the length of the pair of first engaging portions such that at least one of the pair of the second engaging portions is not engageable with the first protrusion/recess-formed portions provided on the both side surfaces of the first frame in a case that an attempt is made to engage the pair of second engaging portions with the first protrusion/recess-formed portions and/or that at least one of the pair of the first engaging portions is not engageable with the second protrusion/recess-formed portions provided on the both side surfaces of the second frame in a case that an attempt is made to engage the pair of first engaging portions with the second protrusion/recess-formed portions.

15. The filter apparatus according to claim 10, wherein rotary bearings are provided on the first and second engaging portions at portions thereof which contact with the first and second frames, respectively.

16. The filter apparatus according to claim 10, wherein the first filter box is provided as a plurality of pairs of first filter boxes and the first engaging portion is provided as a plurality of pairs of first engaging portions; and
the second filter box is provided as a plurality of pairs of second filter boxes and the second engaging portion is provided as a plurality of pairs of second engaging portions.

17. An exposure apparatus which exposes a substrate with an exposure light via a pattern, the exposure apparatus comprising:
an exposure apparatus-body section which exposes the substrate and a chamber which accommodates the exposure apparatus-body section;
the filter apparatus as defined in claim 10; and
an air-conditioning apparatus which feeds a gas taken in from outside of the chamber into the chamber via the filter apparatus.

18. A method for producing a device, comprising:
exposing a photosensitive substrate by using the exposure apparatus as defined in claim 17; and
processing the exposed photosensitive substrate.
